(19) United States
(12) Patent Application Publication
(10) Pub. No.: US 2010/0269158 A1
(43) Pub. Date: Oct. 21, 2010

(54) SOCIAL NETWORKING SITE AND SYSTEM

(75) Inventors: Dwain Ehler, Russell (CA); Philippe Dame, Ottawa (CA); Alfred Jay, Ottawa (CA)

Correspondence Address: Brion Raffoul, PO Box 40060, 2515 Bank Street, Ottawa, ON, K1V 0W8, CA

(73) Assignee: RAMIUS CORPORATION, Ottawa, ON (CA)

(21) Appl. No.: 12/808,164

(22) PCT Filed: Dec. 16, 2008
(86) PCT No.: PCT/CA2008/002168

§ 371 Date: Jun. 14, 2010

Related U.S. Application Data
(60) Provisional application No. 61/006,071, filed on Dec. 17, 2007.
(60) Provisional application No. 61/071,639, filed on May 9, 2008.

(51) Int. Cl. G06F 21/20

(52) U.S. Cl. 726/4

(57) ABSTRACT

Various methods and systems are described for use in operating and maintaining a user subscribed system, such as a website or network. For example, a social networking site or network is contemplated with a member account having one or more member profiles associated with his or her member account. In accordance with one embodiment of the invention, the described systems and methods may provide a user selective access to member-related information, such as topic-based electronic content associated with the member, member-related or identifying information, and other such information, in accordance with member selected categorization and/or organisation. Users may be categorized hierarchically into contact groups, such that access to member-related information by user in a given contact group depends on the permission rights granted to that contact group. The methods and systems described provide a scalable infrastructure to support large volumes of users and requests in a network while ensuring a high degree of fault tolerance, so as to minimize service interruptions and unexpected data loss, for example.

### FIELD OF THE INVENTION

The invention relates to information and computer technology. More specifically, the invention relates to a social networking site and system.

### BACKGROUND

The Internet has grown from a collection of networked computers for use by academia and the military into what some proponents consider a panacea to the world's ills. The Internet is currently used for everything from providing almost instantaneous access to worldwide communications (e.g. VOIP, email) to accessing both relevant and irrelevant minutiae (e.g. information websites such as Wikipedia™). In fact, the Internet has even been recruited to cure one of the standbys of the human condition—loneliness. The rise of Internet dating from the fringes of society into the mainstream is testament to the power of what can be done with technology. This seeming ubiquity of Internet dating websites has led to a more benign form of contact based networking—the social networking website.

Websites such as MySpace™ and Facebook™ have enabled long-lost friends to contact one another, co-workers to collaborate on projects, and have also enabled people to expand their network of friends. These websites allow people to post their profiles, upload pictures, videos, and other multimedia files for consumption by their friends if not the world at large.

However, while such social networking websites allow users' friends to access such user uploaded content, some users may not want their content accessible by all their contacts or by the world at large. Furthermore, to date, no social networking software or website allows the user to organize his or her content by topic. Currently, such websites only allow content to be grouped by content type or by application.

Therefore there is a need for a new method, system and data structure that overcomes some of the drawbacks of known technology.

This background information is provided to reveal information believed by the applicant to be of possible relevance to the invention. No admission is necessarily intended, nor should be construed, that any of the preceding information constitutes prior art against the invention.

### SUMMARY OF THE INVENTION

An aim of the invention is to provide a social networking site and system.

A further or alternative aim of the invention is to provide a social networking site and system with member-related information categorization.

A further or alternative aim of the invention is to provide a social networking site and system with topic-based organisation.

A further or alternative aim of the invention is to provide a social networking site and system enabling multiple member profiles. In accordance with one aspect of the invention, there is provided a method for providing selective access to electronic content associated with a member of a social networking system, the method comprising the steps of: (a) generating a member account having at least one topic-based content collection; (b) associating at least one electronic content item with at least one of the topic-based content collections responsive to a content selection action implemented via the member account; (c) identifying at least one user as authorized to access the at least one electronic content item responsive to a user selection action implemented via the member account; and (d) providing access to the at least one electronic content item, associated with at least one of the topic-based content collections, only to the at least one user identified as authorized in step (c). In accordance with another aspect of the invention, there is provided a computer readable medium comprising statements and instructions for execution by a computing device to provide selective access to electronic content associated with a member of a social networking system in accordance with the following: (a) generating a member account comprising at least one topic-based content collection; (b) associating at least one electronic content item with at least one of the topic-based content collections responsive to a content selection action implemented via the member account; (c) identifying at least one user as authorized to access the at least one electronic content item responsive to a user selection action implemented via the member account; and (d) providing access to the at least one electronic content item, associated with at least one of the topic-based content collections, only to the at least one user identified as authorized in step (c).

In accordance with another aspect of the invention, there is provided a method for providing selective access to identifying information associated with a member of a social networking system, the method comprising the steps of: (a) generating a member account having at least one member profile; (b) associating identifying information with at least one of the member profiles responsive to an information association action implemented via the member account; (c) identifying users authorized to access at least one of the member profiles responsive to a user selection action implemented via the member account; and (d) providing access to identifying information associated with at least one of the member profiles only to users identified as authorized to access the at least one of the member profile.

In accordance with another aspect of the invention, there is provided a computer readable medium comprising statements and instructions for execution by a computing device to provide selective access to electronic content associated with a member of a social networking system in accordance with the following: (a) generating a member account having at least one member profile; (b) associating identifying information with at least one of the member profiles responsive to an information association action implemented via the member account; (c) identifying users authorized to access at least one of the member profiles responsive to a user selection action implemented via the member account; and (d) providing access to identifying information associated with at least one of the member profiles only to users identified as authorized to access the at least one of the member profile.

In accordance with another aspect of the invention, there is provided a social networking system for providing selective access to electronic content associated with a member of the system, the system comprising: at least one data storage device for storing data associated with an account of the member and at least one topic-based content collection thereof, the data comprising collection-related data for each of the topic-based content collections, user-related data for at least one user, and content-related data associated with the electronic content; and at least one processing module operatively coupled to the at least one data storage device and configured with: at least two user interface components for implementing an account management interface enabling a content association function and a user association function; a content association component for implementing, responsive to the content association function, association of the content-related data with the collection-related data of a selected topic-based content collection; and a user association component for implementing, responsive to the user association function, association of the user-related data of a selected user with the content-related data and the collection-related data of the selected topic-based content collection; wherein the at least two user interface components are constructed and arranged for implementing a user interface for providing access to the electronic content only to the selected user.

In accordance with another aspect of the invention, there is provided a social networking system for providing selective access to identifying information associated with a member of the system, the system comprising: at least one data storage device for storing data associated with an account of the member and at least one member profile thereof, the data comprising profile-related data for each of the profiles, user-related data for each of a plurality of system users, and identifying information-related data associated with the identifying information; and at least one processing module operatively coupled to the at least one data storage device and configured with: at least two user interface components for implementing an account management interface enabling an identifying information association function and a user association function; an identifying information association component for implementing, responsive to the identifying information association function, association of the identifying information-related data with the profile-related data of a selected profile; and a user association component for implementing, responsive to the user association function, association of the user-related data of a selected system user with the profile-related data of the selected profile; wherein the at least two user interface components is further for implementing a user interface for providing access to the identifying information via the selected profile only to the selected system user.

In accordance with a further aspect of the invention, there is provided a method for operating a social networking site, said site having a plurality of users, the method comprising: receiving input from each user comprising contact information for a plurality of said user's contacts; receiving organizational information from each user for each of said user's contact for use in organizing said user's contacts into categories; categorizing each user's contacts based on said user's organizational information for each contact; for each user, presenting said user's contacts to said user in an organized manner reflecting said user's organizational information for each contact.

Other aims, objects, advantages and features of the invention will become more apparent upon reading of the following non-restrictive description of specific embodiments thereof, given by way of example only with reference to the accompanying drawings.

### BRIEF DESCRIPTION OF THE FIGURES

The embodiments of the invention will now be described by reference to the following figures, in which identical reference numerals in different figures indicate identical elements and in which:

FIG. 1 illustrates a block diagram of a highly scalable infrastructure for a large participation social network according to one aspect of the invention;

FIG. 2 illustrates a schematic of a high density data storage format for a node's full ancestry in a logical hierarchy according to another aspect of the invention;

FIG. 3 illustrates an example of a system for storing the entire ancestry in each node of a logical hierarchy for rapid selection and manipulation and how it may be used according to an embodiment of the invention;

FIG. 4 illustrates an implementation sample system for topic folders that support multiple item types according to an embodiment of the invention;

FIG. 5 illustrates a block diagram for a system permitting users in a social network to group their contacts to control the disclosure of profile information and how these may be grouped according to an embodiment of the invention;

FIG. 6 illustrates a sample implementation of a system permitting users in a social network to have multiple profiles while storing common information in a base profile according to an embodiment of the invention;

FIG. 7 shows a flowchart detailing the steps in a process for completing a base profile and setting up an extended profile which may be used with aspects of the invention;

FIG. 8 shows a flowchart detailing the steps in a process for creating a contact group, assigning contacts and sharing profiles according to an embodiment of the invention;

FIG. 9 shows a flowchart detailing the steps in a process for viewing a user profile which may be used with aspects of the invention;

FIGS. 10A and 10B show a flowchart detailing the steps taken when users request to be a contact of another user according to an embodiment of the invention;

FIGS. 11A and 11B show a flowchart detailing the steps taken when publishing an item to a topic folder and how another user views the item according to an embodiment of the invention; and

FIG. 12 shows a schematic diagram of a graphical user interface implemented by a networking system, in accordance with an embodiment of the invention, enabling a member of the system to manage information to be selectively displayed to various authorized users of the system.

FIG. 13 shows an exemplary screen shot of a graphical user interface implemented by a networking system, in accordance with an embodiment of the invention, enabling a member of the system to manage content to be selectively displayed to various authorized users of the system.

FIG. 14 shows an exemplary screen shot of a graphical user interface implemented by a networking system, in accordance with an embodiment of the invention, enabling system users to view a member's profile.

FIG. 15 shows an exemplary screen shot of a graphical user interface implemented by a networking system, in accordance with an embodiment of the invention, enabling a member to select contact groups that will have access to a particular content item.

FIG. 16 shows an exemplary screen shot of a graphical user interface implemented by a networking system, in accordance with an embodiment of the invention, enabling a member to generate a personal home page.

### DETAILED DESCRIPTION OF THE INVENTION

The following describes, in accordance with different embodiments of the invention, various methods and systems for use in operating and maintaining a user subscribed system, such as a website or network, for example, a social networking site or network. For example, and in accordance with one embodiment of the invention, the described systems and methods may provide a user selective access to member-related information, such as topic-based electronic content associated with the member, member-identifying information, and other such information, in accordance with member selected categorization and/or organisation.

For instance, the described embodiments of the invention may provide a social networking site and system with topic-based organisation, wherein member-related electronic content is categorized and/or organised in accordance with one or more topic-based content collections. The described embodiments may also, or otherwise, provide a social networking site and system enabling multiple member profiles, wherein member-related and/or identifying information is categorized and/or organised in accordance with one or more member profiles, which may be based on one or more predefined criteria and/or criteria defined by the member.

For example, and in accordance with one embodiment, the described systems and methods may provide a user of the system selective access to member-related information associated with a member (e.g. a registered user) of this system, wherein the rules on which this selective access is provided is established by the member. In such a system, a member account could be generated and configured to comprise one or more topic-based content collections and/or one or more member profiles, to each one of which electronic content and/or member-related information may be associated respectively in a topic- and/or role-based organisation, for example, as selected by the member via an account management tool provided by the system. In order to provide selective access to this electronic content and/or member-related information, authorized users may be selected by the member for each of the collections, or content items thereof, and/or for each of the profiles such that access to electronic content and/or information associated with a given collection or profile is only provided to authorized users.

For the purpose of description, it will be appreciated by the person skilled in the art that while certain terms are used herein to describe various embodiments of the invention, such terms should not be construed in a limiting manner, as other terms may be equally applicable in this context to refer to similar implementations of the invention herein considered. For example, as introduced above, a member account may refer to a member's particular membership status to the systems and networks herein described. Such accounts may thus be considered to include, for example, various system parameters and/or member information characterizing this account. For instance, the member account may include, but is not limited to, personal member data and operational parameters defined for governing member access to the member's account, for example to generate, upload, link and/or manage electronic content and/or information associated or to be associated with this account, and for governing user access to the electronic content and/or information associated with this account by different users of the system.

In addition, a member account may be configured to include one or more topic-based content collections and/or one or more member profiles, which generally refer to collections/profiles created, generated and/or associated with the account of a system member. In general, each of these collections/profiles will include, and/or have associated therewith, various electronic content/information selected, created and/or generated by the member, and to which one or more system users, or categorized group or subgroup thereof (also referred to herein as contract groups and subgroups), may be selectively authorized access. In general, a collection or profile may be formed on the basis of the member's personal relationship with one or more other system users known by the member, for example grouping one or more of family members, friends, teammates, members of a social affiliation, coworkers, colleagues, etc. Similar profiles/collections may equally be defined as a function of the member's interest(s), such as musical, athletic, artistic, political, academic, business, economic and/or personal interests, to name a few, and a commonality of this or these interests with one or more other system users known or even at first unknown to the member. Other examples of member profiles/collections may include, but are not limited to, open profiles/collections to which every visiting and/or subscribed user of the system may have access, administrative profiles to which only the member, or one in possession of the member's administrative access information, may have access, and the like. It will be appreciated by the person of ordinary skill in the art that various other characteristics may be used to form the basis for additional and/or alternative profiles/collections, as will be described with reference to the following exemplary embodiments of the invention.

As referred to above, and in accordance with one embodiment of the invention, each member profile will generally have associated therewith, member-identifying information selected, uploaded, generated and/or otherwise associated by the member for access by selectively authorized users. Examples of member-identifying information may include, but are not limited to: member name(s), nickname(s), family members, relevant dates (e.g. date of birth, graduation(s), marriage, etc.), occupation, employer, speciality(ies), favourites (e.g. movies, books, plays, music, food, colour, restaurants, etc.), profile photo(s), coordinates (e.g. mailing address(es), phone number(s), e-mail address(es), pager(s), etc.) and other such information as will be readily apparent to the person of ordinary skill in the art.

In accordance with one embodiment of the invention, multiple member profiles are enabled by the system, thereby allowing a member to present a different profile to different system users, or groups thereof, each comprising a different set or subset of member-identifying information as defined by the member. For example, a member can manage two profiles wherein information associated with a same field of each profile is different based on the users selected by the member for authorized access to each profile. Namely, a family profile may provide authorized users access to a member's home address, while a corporate profile may provide authorized users, which may differ from those authorized to access the personal profile, a business address. Other examples will be provided below.

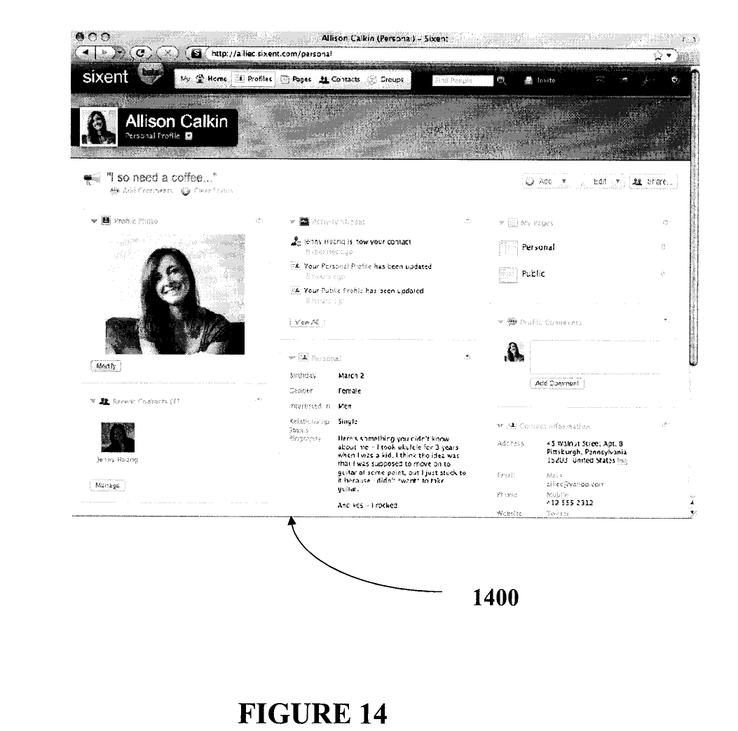

FIG. 14 is an exemplary screen shot of a graphical user interface 1400 implemented by a networking system, in accordance with an embodiment of the invention, enabling system users to view a member's profile. The profile shown in FIG. 14 is a “personal” profile—one of two profiles for this particular member, as the member also has a “public” profile.

Furthermore, and in accordance with one embodiment of the invention, each topic-based collection will generally have associated therewith, electronic content (e.g. content items) selected, uploaded, generated and/or otherwise associated by the member for access by selectively authorized users. Examples of electronic content may include, but are not limited to: uploaded data and/or digital media, such as text, video, audio and/or image media files; links to such media files stored and/or managed by a third party system; original work created and/or generated through the system, such as data and/or text entries, commentary, blogs, calendar and/or upcoming event entries, digital invitations and/or meeting requests, and the like; and other such electronic content as will be readily apparent to the person of ordinary skill in the art.

In accordance with one embodiment of the invention, a topic-based data structure, such as for example a hierarchical based data structure, is provided and used to store and manage topic-based collections and electronic content associated therewith. In general, the described system, and exemplary data structures thereof, allows members to generate multiple topic-based collections and to manage access to those collections by other users based on whatever criteria the member chooses. This system may further enable a member to organize content uploaded thereby into categories based on topics and not based on tools, for example, as is common in known systems, thereby enabling different content types to be associated with a same collection. As will be discussed in greater detail below, a same or similar structure may also be implemented, in one embodiment, to support the multiple profiles of each system member.

As noted above, one context applicable in various embodiments of the invention relates to a social networking website for use by multiple users. Such a website would allow individual users to create and manage multiple profiles and control other users' access to these profiles. As such, a member (e.g. registered user) can have different profiles and have each profile only accessible by different groups of their contacts that are selected by the user as being relevant or appropriate to the particular category forming the basis for this profile. A member can therefore have, for example, one profile for their acquaintances, another profile for their relatives, and yet another, different profile for their close friends. Similarly, a member can have one profile accessible only by their co-workers, one profile for people with whom they share one specific interest, and another profile for people they consider as potential mates. In one embodiment, this may be done without any of the other groups of users even knowing of the existence of other profiles. Each profile would be independent of the other profiles.

This concept of multiple profiles can also be applied to other types of websites such as Internet dating websites. As an example, a user may have one somewhat revealing profile that is available to all registered users of the website while having a more constrained and less revealing profile available to non-registered users. Furthermore, the same user can have yet another, even more revealing profile available to registered users with whom the user has already had previous contact. In addition, or alternatively, a person could generate different topical profiles based on different interests, for instance having a profile available to registered users interested in outdoor activities, fine dining, and motor sports respectively. Currently, websites that offer matching services or introduction services only allow users a single independent profile in a “one size fits all” approach.

In addition or alternatively, different embodiments of the invention enable user-generated or user-uploaded content to be organized by topic as well as being constrained as to access by other users. In other words, a user may upload digital content and control which of his or her contacts can access this content based on the topic-based collection to which this content is associated. Thus, a user may upload multiple digital photographs and have his or her relatives only able to access some of these photographs. Similarly, a member's co-workers who are also registered users of the website may only be able to access some of these digital photographs. However, it should be noted that controlling access to digital content needs not only be made on the basis of the user's relationship with his or her contacts. Some content may also have its accessibility determined by commonality of interest with the uploading user. As an example, a user who is interested in fencing may upload fencing videos and such videos would only be accessible to that user's contacts who are also interested in the same sport. Similarly, other topic dependent content may be organized by the user in a topic specific manner.

For example, all fencing related content uploaded or generated by that user would be logically placed in a fencing folder and access to that folder (e.g. collection) would be limited only to that user's contacts who were also interested in fencing. Multiple levels of organization may also be used to further categorize content. Continuing with the fencing example, the user may further subdivide the content by weapon such that all content related to the epee fencing weapon would be in one subfolder, all content related to the foil fencing weapon would be in a second subfolder, and all content related to the saber fencing weapon would be in a third subfolder. Of course, access to these subfolders would be determined by the user on any basis that the user may wish. For example, users authorized to access a parent folder may automatically be authorized to access all child or sub-folders to this parent folder. Alternatively, or as a separate option, access to each sub-folder may be independently defined. Another alternative would be to have access rights to each sub-folder be independent of its parent folders so that users who have access to the sub-folder do not necessarily or automatically have access to the parent folders. In another option, access to a given folder may be defined while access to each item within this folder may be further defined or restricted based on the nature of each item. It will be appreciated by the person of ordinary skill in the art upon reading the following description that other options and permutations may be considered herein without departing from the general scope and nature of the present disclosure.

In accordance with one embodiment, the above described website and its capabilities is enabled by a hierarchical logical organization of a site or system database. In general, the underlying layer of many social networking websites or, indeed, many websites that involve massive amounts of users, comprises that of a database. In such systems, each user registered in the website is allocated a database entry and anything he or she enters in his or her user profile is recorded in the database. Contacts between registered users in such websites are recorded as references in each other's database entries. Currently, such websites and their underlying database structure use a tool based approach—entries and content are grouped by what tools are required to access, edit, or view the content. Thus, photographs are all grouped together since a specific tool is required to view such content. Similarly, videos are grouped together since a specific tool is required to play such content. However, this current structure only allows a binary access model—for each user's content, that user can only allow or deny access to the content to all or none of his or her contacts, especially since the grouping is tool based. Additionally, a more important weakness of the tool-based approach is the loss of context for the content. In a tool-based approach, pictures, files, video, and discussion relating to a single topic need to be separated into the various tools needed to access them. As such, users cannot consistently see all content related to a single topic or context.

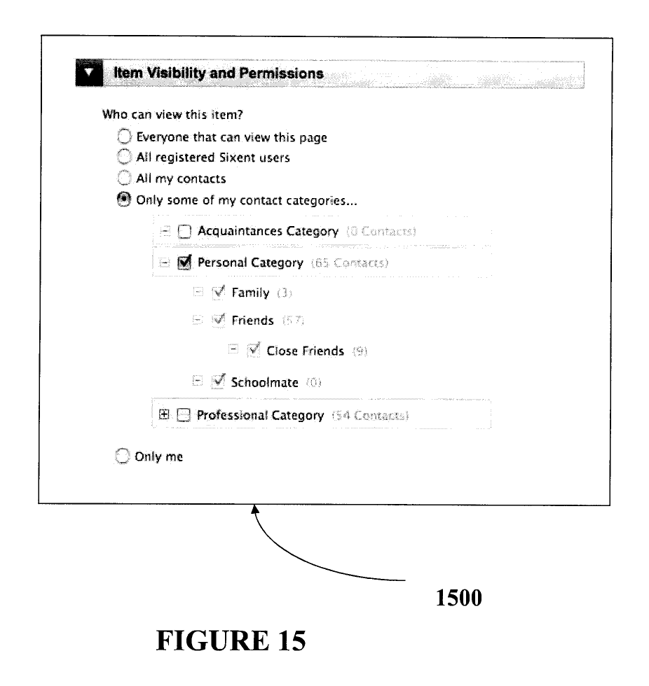

For example, FIG. 15 is an exemplary screen shot of a graphical user interface 1500 implemented by a networking system, in accordance with an embodiment of the invention, enabling a member to select contact groups that will have access to a particular content item. In this example, the member has given access to all users in the member's “personal” category, but has denied access to all users in the “acquaintance” and “professional” category.

In addition, one embodiment of the invention contemplates that the described systems and methods enable existing users to invite non-users to join the networking site. For example, the system enables a member to send an e-mail invitation to a non-user's e-mail account. When an invitation is sent by a member to a non-user, a unique identifier (ID) is assigned to the non-user and a shell member account is created for that non-user. Before sending the invitation, the member can also categorize the non-user into a contact group. Similarly, the member can assign different permission levels of access by the non-user to the member's account and its associated electronic content. When the non-user decides to join the networking site, the shell user account is associated with a new member account. Because the relationship between the member and the non-user can be set up before the member joins, the need for the member to define the permission levels of access once the non-user joins is eliminated. Rather, these permission levels were stored as data associated with the unique ID for that particular shell user account. Thus, once the non-user registers with the site, the non-user gains immediate access to the electronic content made available to the non-user by the inviting member.

To implement different embodiments of the above website, a system of servers may be used. These servers may be used in conjunction with a data storage configuration that enables, in accordance with one embodiment, a hierarchical organization of user profiles, categorized/contact groups of users, and/or content into nested levels.

For example, and in accordance with one embodiment of the invention, a social networking system is configured for providing selective access to electronic content and/or identifying information associated with different members of the system. The selective access can be organized in a hierarchy, such that some electronic content in a collection is accessible to a general category of users whereas other electronic content accessible only to a sub-category of users within that general category.

The system generally comprises at least two data storage devices (e.g. databases) for storing data associated with respective member accounts, at least some of which each having one or more member profiles and/or one or more topic-based content collections defined therein.

As described above, these profiles/collections may be defined by the member, or again consist of standard or proposed system profiles/collections applicable to a large cross section of system users and/or groups of users. As will be described in greater detail below, the data storage device(s) will be configured to store and maintain data relevant to the operation of the system, including for each account, for example, but not limited to, profile- and/or collections-related data for each of the account's profiles/collections, user-related data for each of a plurality of system users associated with one or more of the account's profiles/collections, and information/content-related data associated with the electronic information/content associated with each of the profiles/collections.

The system will further generally comprise one or more processing modules, for example implemented by one or more system servers or the like, operatively coupled to the data storage device(s) for communication between them and configured with various functional components adapted to enable and implement operation of the system.

The system will also generally comprise at least one user interface component for implementing an account management interface enabling a member to manage and coordinate information/content associated or to be associated with their account and its various profiles/collections. Various examples of such user interfaces are described in greater detail below. Such an interface may further provide additional functional features enabling various interactions of the member with other users of the system and/or with information/content associated with other user accounts and profiles/collections to which they have access. A same or additional user interface component may further be provided to implement a user interface for enabling an authorized user access to the electronic information/content associated with a member profile/collection to which he or she is authorized access.

In one embodiment, the management interface will be configured to provide the member with an information/content association function and a user association function respectively enabling the association of information/content and users with selected profiles/collections, for example, in a user-selected organisation. In order to implement these associations, the processing module(s) may further comprise an information/content association component for implementing, responsive to an information/content association function operated by the member, association of information/content-related data with profile/collection-related data of a selected profile/collection. A user association component may also be provided for implementing, responsive to a user association function operated by the member, association of user-related data of selected system users with one or more of content-related data and profile/collection-related data of a selected profile/collection.

It will be appreciated by the person of ordinary skill in the art that additional and/or alternative system modules and/or components may be considered herein to implement different embodiments of the invention without departing from the general scope and nature of the present disclosure.

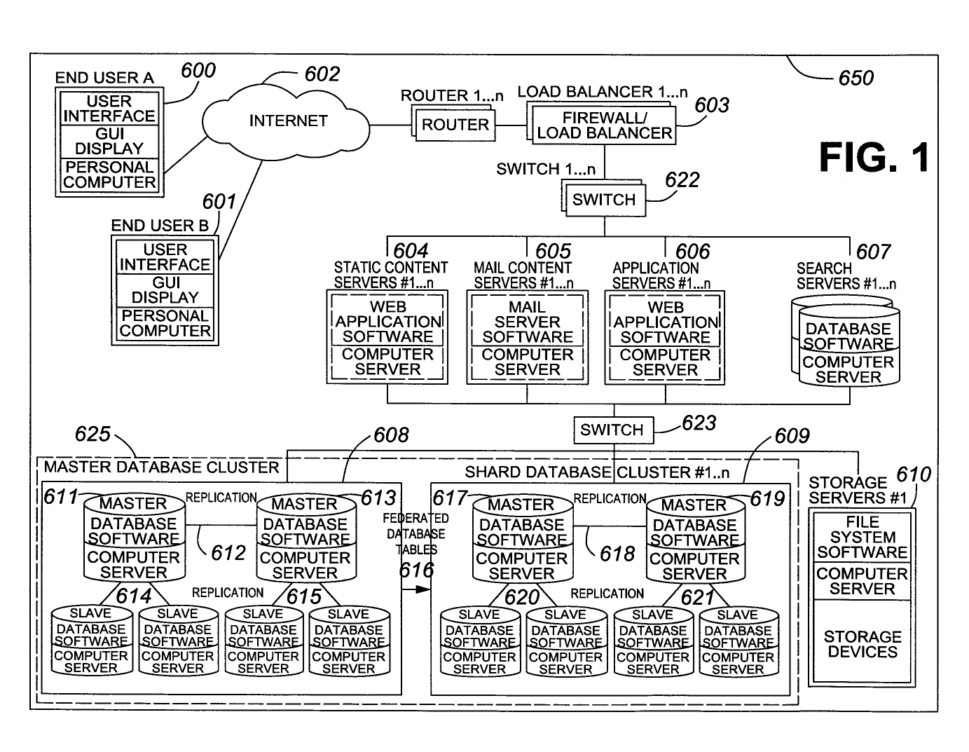

As an example, and in accordance with one embodiment of the invention, a hardware infrastructure for use in implementing a social networking system is described below with reference to FIG. 1. It will be appreciated by the person of ordinary skill in the art upon reading the following example, that alternative or modified infrastructures may be considered herein without departing from the general scope and nature of the present disclosure.

As depicted in FIG. 1, one embodiment of the invention provides a scalable infrastructure 650 to support large volumes of users 600, 601 and requests in a social network while promoting or even ensuring a high degree of fault tolerance, so as to minimize service interruptions and unexpected data loss, for example.

In this embodiment, the central portion of the infrastructure comprises an application server tier made up of a clustered set of computer servers 604, 605, 606, 607. These systems serve to execute the social networking application software that handles all key requests for data and services from the social network site. All such requests are brokered through a load balancer 603 that distributes requests evenly across the multiple application servers (#1 . . . n) 606 for maximum performance. The load balancer provides fault tolerance by automatically excluding application servers that do not meet a minimum performance requirement, for example, through a switching means 622.

All application servers 606 in the cluster are aware of one another and can communicate via a broadcast channel (not shown) over the network infrastructure. Communications between machines are broadcast to help the separate servers remain synchronized (e.g., invalidate stored memory objects that have been invalidated in one system but remain in a separate server).

Content and supporting site elements that remain largely unchanged over time may be considered “static content” and are handled by another pool of application web servers, the static content servers 604. The static content servers 604 act independently of the application servers 606 and thus allow requests to be satisfied in a stateless manner (i.e., not associated to an existing user session stored by an application server). All static content will be stored on an array of network storage servers 610, which can be accessible by both the static content servers 604 and the application servers 606, through switching means 623.

All information about users in the social network is stored and retrieved from an array of database servers 625. The array of database servers includes the master database cluster 608 and the shard database cluster 609 that is operatively coupled to the master database cluster 608. The master database cluster 608 contains a record for each user in the system and is used for finding a user (e.g., login and registration of users). The master database cluster is comprised of two write masters 611 and 613 that write to each other in a replication ring setup 612, and each master has a variable set of replicated read-only slave databases 614 and 615.

The bulk of user data that is stored in the array of database servers 625 will be stored in one of several shard database clusters 609. The shard database cluster 609 is similar in structure to the master database cluster 608 except its purpose is to store mass quantities of user data, whereby one shard database cluster's set of data does not overlap with another. A shard database cluster is defined here as a set of database servers that manage one portion of a larger data set, whereby each shard's data is typically used together. Since a shard database cluster is limited by its physical storage, the number of shard database clusters can grow as the user base grows. A shard database cluster is also comprised of two write masters 617 and 619 in a replication ring setup 618 and several replicated read-only slave databases 620 and 621.

All application servers 606 will query a shard database cluster directly (through switching means 623) using a user's primary key to determine which shard they belong to. The primary key is a user's unique identifier (ID) that will be assigned to each user, either upon subscription by the user to the networking site or upon an invitation being sent to that user to join the networking site. The user's primary key is first fetched from the master database cluster 608.

The main limitation to using shards in a social networking site is that all user data is dispersed across the many database clusters. To fetch information about many users would require querying several shards and piecing the different results together in memory in an application server 606.

However, to allow queries to fetch information about several users in a single query, the concept of federated database tables 616 has also been implemented in this embodiment. A federated table is a virtual table that points to a remote database, but acts as if it is native to the current database, like a proxy. This allows a single query to connect directly to the remote table as if it were local to the database.

Further, to achieve the single query that simulates the spanning of multiple database shards, core information about each user is stored in the master database cluster 608 as a set of tables. Each shard database cluster 609 then creates a local federated table that is resolved to the master database cluster version of the table, known as the main federated table. In other words, the master database cluster's database tables are federated into the shards. The shard database cluster 609 therefore sees the main federated table. Accordingly, a single query can now join, sort and filter that data based on a complete cross-shard set of user data.

The system is also contemplated as having a multi-tenant architecture in accordance with another embodiment of the invention. With a multi-tenant architecture, the system database is designed to virtually partition its data and configuration for separate and distinct client organizations. The system enables client organizations to work with a customized virtual application of the networking site whereby their data is retrieved from and stored in virtual separate shard database clusters. Thus, the members of the client organization can be virtually segregated from all other site members. The data for one client organization can reside on the same physical database shard as other organizations but there is virtual segregation that separates the data from one organization from data for other users.

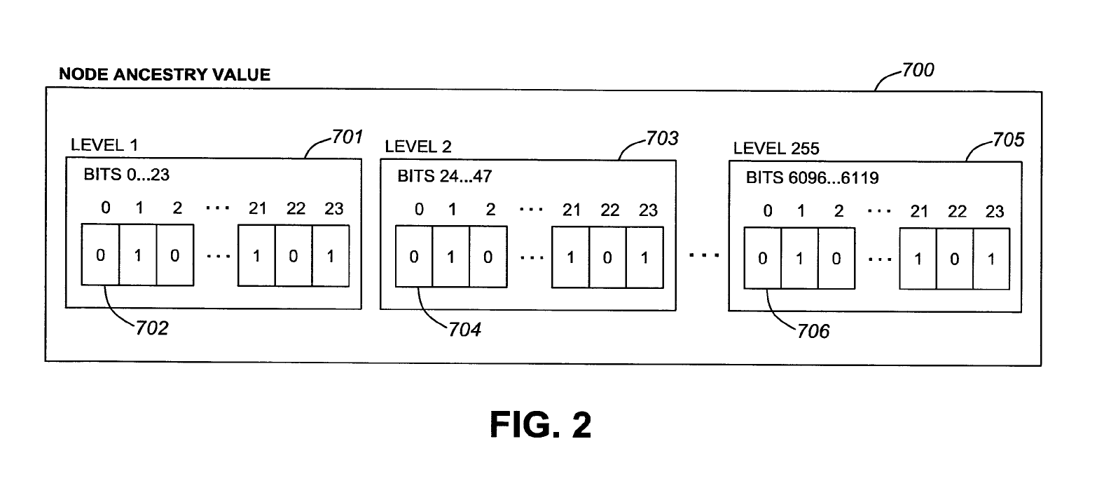

Regarding the above-noted data storage configuration, reference is now made to FIG. 2, wherein a high-density data storage format is depicted, in accordance with one embodiment of the invention. In this example, the data storage configuration uses a raw byte array to store not just the unique ID for each node, but also that node's ancestry. Thus, if one has a tree array structure, each bottom leaf in the tree array (and every other leaf in the tree) can have not just its unique ID but also its ancestry (its parents, grandparents, and every other node it is related to) stored in one array.

A typical logical hierarchy requires a mechanism to persist the relationship between the nodes (i.e. parent and child relationships). There are several existing techniques in the prior art that already manage these relationships. Existing techniques vary from the simple storage of a node's immediate parent, to the full storage of a node's ancestry in a separate index or lookup table. The difficulty with existing techniques is that they may allow rapid reading, segmentation, pruning or manipulation of the hierarchy, but never all of these benefits together.

In this embodiment, a data storage format is provided that allows for the efficient tracking of a node's full hierarchy, such that a database structured query language (SQL) query can read, segment, prune and manipulate the hierarchy in a single query regardless of the size or complexity of the entire hierarchy.

In order to enable such functionality, this ancestry information is stored in a highly compact format that is natively accessible by common database platforms. For example, the ancestry information can be stored directly with the node itself rather than in an external index or database lookup table.

In one embodiment, a hierarchy stored in a database is accessed and modified via SQL queries (e.g. selection, insertion, modification and deletion of database table entries, etc.) wherein at least some, if not most key operations on the hierarchy require only a single SQL statement to be executed. This feature may greatly improve performance of an application that is highly dependant on hierarchies.

In the example of FIG. 2, the full ancestry path 700 of each node is stored to an industry standard database field or object type known as a “varbinary”. Once retrieved from the database, this object can then be accessed within the application as a raw byte array.

In general, every node in a hierarchy will have a unique ID to identify itself and its relationship to other nodes. FIG. 2 illustrates a hierarchy, in accordance with one embodiment, where nodes have a unique ID that is limited to a 24-bit number 701. It will be appreciated that higher or lower limitations may be considered depending on application and system requirements/restrictions, without departing from the general scope and nature of the present disclosure. As known, a byte generally consists of 8 bits and so the above-limited ID can also be a 3-byte ID (8 bits per byte). When a 24-bit ID is used, it will be appreciated that 16,777,215 possible unique IDs are thus available, which provides a reasonably high limit suitable for most applications. It will be appreciated by the person of ordinary skill in the art that the size (e.g. bit size) of the ID can be varied if desired depending on the application for which it is used.

In accordance with one embodiment, to store a node's full ancestry path as a consecutive set of IDs (i.e. level by level), a byte array is arranged up to a maximum of “n” levels in depth. FIG. 2 illustrates an example of a byte array 700 where a maximum of 255 hierarchical levels is desired. It will be appreciated that the number of hierarchical levels can be varied if desired, again depending on system and application requirements/limitations and/or other such requirements/limitations.

Since the storage of ancestry information in each node may vary, the array size for each node may also be variable. For example, a node that is only a few levels deep does not require as much memory to store its ancestry path as does a node hundreds of levels deep. This attribute may thus contribute to the efficiency of this technique.

For example, a node that is three levels deep in its hierarchy would have only two ancestor IDs to track and thus to store. Namely, there would only be a value for level 1 (701) and level 2 (703), resulting in an ancestry path size of 48 bits or only 6 bytes of data.

Accordingly, the maximum number of levels in this approach is flexible as it is based only on the underlying data storage limitations. A practical implementation constraint that may exist is the maximum size of a varbinary field in a given database that can be indexed. While it is possible to exceed this limit, a decrease in efficiency would generally result. It will be appreciated by the person of ordinary skill in the art that such decrease in efficiency may nonetheless be considered appropriate in a given context.

In the example of FIG. 2, a limit of 255 levels is depicted. Still, a node at the 255th level (i.e. level 705) would require only 765 bytes to store it entire ancestry. As an example, this sample size of 765 bytes is the current indexable limit of the MySQL database platform's varbinary field type. It will be appreciated that similar systems build on other database platforms having different varbinary field type limits can equally be considered herein to provide similar results and advantages.

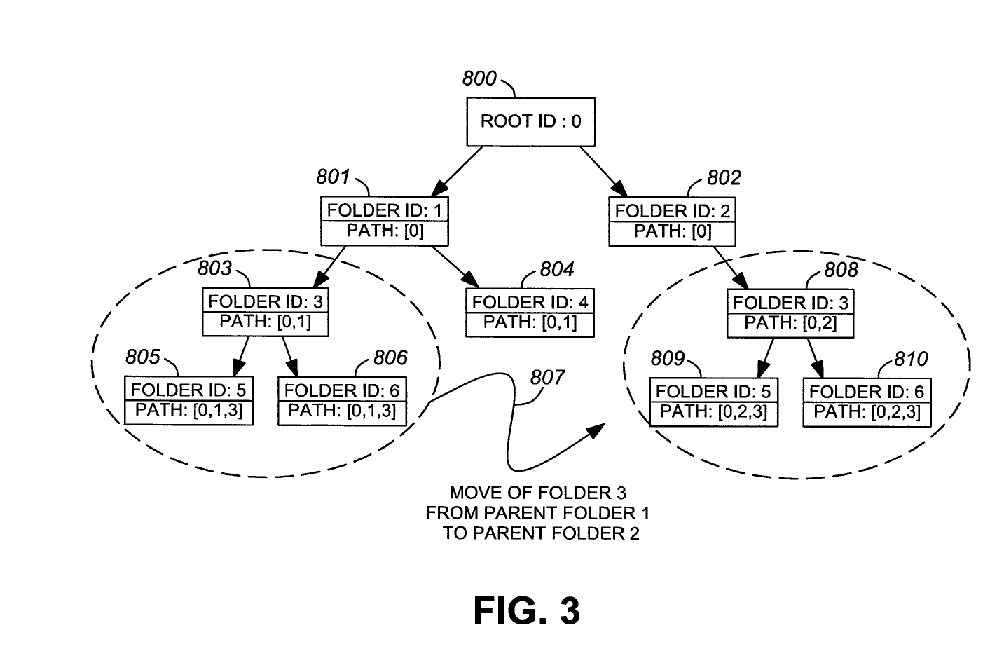

Referring now to FIG. 3, and in accordance with one embodiment of the invention, the advantages of the above storage technique are further exemplified when applied to a folder hierarchy in a social networking site or system.

As noted above, the data storage structure noted in FIG. 2 may be used for both the content and the profiles in a social networking website. In FIG. 3, examples using a folder hierarchy are shown.

Storing a node's ancestry data as outlined in FIG. 2 enables the rapid selection and manipulation of a hierarchy in a single database query. For purposes of illustration, we will discuss a folder hierarchy example in a social networking site.

### EXAMPLE 1

In a folder structure with a single root 800, a single SQL “select” command can be used to retrieve all nodes in order of folder depth. This allows applications to efficiently retrieve and build the folder tree in memory, always ensuring that the parent folders are loaded first so as to not cause orphaned references.

Sample SQL statement:

select * from folders order by length(folder_path);

### EXAMPLE 2

A complete subset or segment of a folder hierarchy can be retrieved by using criteria based on a single node in the folder tree. By selecting data based on the position of Folder 1 (801) in the folder hierarchy, it is possible to quickly identify its two direct child folders, “3” (803) and “4” (804) along with their child folders, “5” (805) and “6” (806).

Sample SQL statement:

SELECT * FROM folders where folder_id=3 or left(folder_path, 9)=“[0][0][0] [0][0][1] [0][0][3]” ORDER BY length(folder_path);

The nine bytes ([0][0][0] [0][0][1] [0][0][3]) represent the complete folder path to folder 3 (803).

### EXAMPLE 3

Once a complete set of folders can be selected in a single query they can be manipulated in a single SQL update. In this example, Folder 3 (803) and all its child folders will be moved to be beneath Folder 2 (802).

Sample SQL statement:

UPDATE folders

SET folder_path=insert(folder_path,1,6,“[][][0] [][][2]”)

WHERE folder_id=3 OR left(folder_path, 9)=“[0][0][0] [0][0][1] [0][0][3]”

By selecting folder 3 (803) and all of its sub folders efficiently, the technique was able to replace the outdated ancestry information (parent folder IDs) with the new ones by using a raw byte array to replace the first 6 bytes. This is done directly in the database without the application having to perform in-memory processing on the complete data set or having to make recursive database calls.

Upon execution of the query in Example 3, the folders and their content remain untouched. The only data elements affected to change their location in the folder hierarchy was the update of 6 bytes of data in each of the three folder nodes 808, 809 and 810.

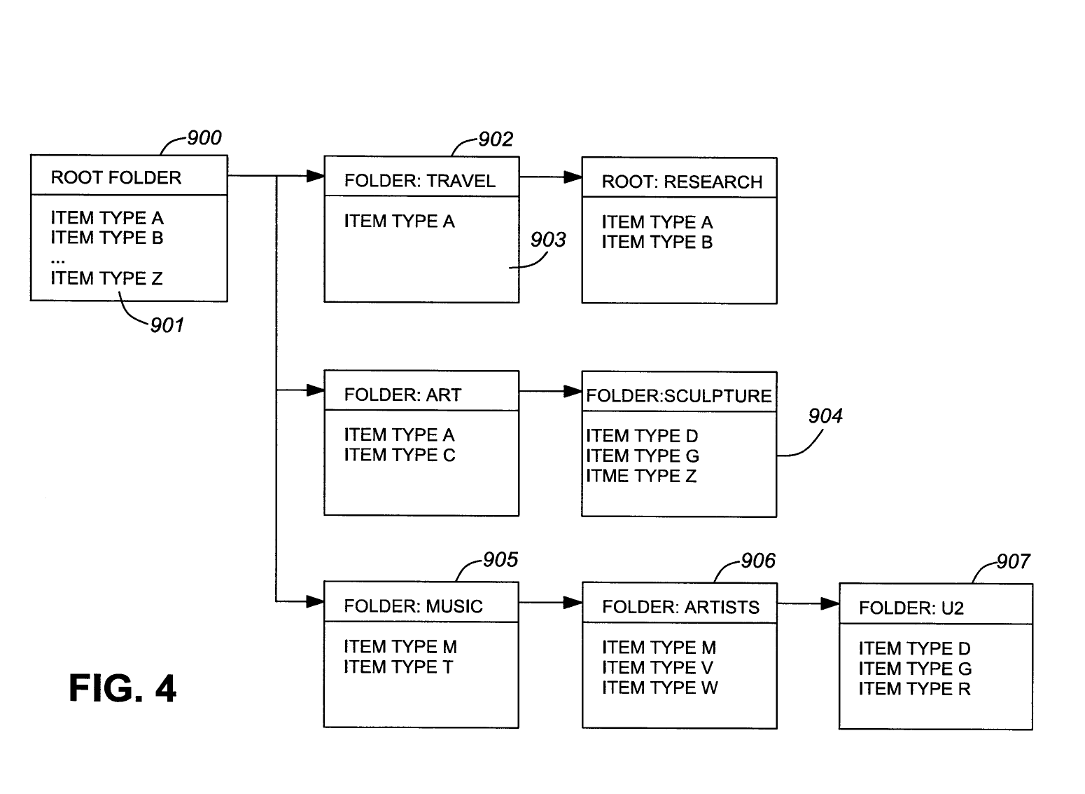

To further clarify the concepts disclosed above, FIG. 4 illustrates a further example of how hierarchical data structures can be used to nest folders and organize digital content.

Typical social networking and collaborative applications require users to store various item types into logically separated areas. This is considered to be a tool-based approach. It typically means items that relate to one another are not stored and retrieved together without additional layers overlaid on the data set to establish additional relationships or data categories.

In accordance with one embodiment of the invention, social networking site users are allowed to create and host many different types of content items and collaborative features (referred to herein as “Item Types” 901) and have those item types co-exist in a single logical container (referred to generally herein as a “content collection” and depicted in this example as “Topic Folders” 900 and 902).

In this embodiment, the topic-based folder is not specific to any item type and thus can be given any name or subject-related heading. This greatly simplifies management of item organization by requiring only a single, consolidated hierarchy. As a result, it also exposes only a single set of access control permissions for users to manage.

The various item types a topic folder can contain might include, but is not limited to, computer files, calendar entries, photos, formatted text postings, databases, discussion topics, videos, audio files, opinion polls, and other such item types as will be readily apparent to the person of ordinary skill in the art.

In one embodiment, a topic folder can also contain other topic folders. As such, a nested tree of topic folder nodes can be defined by a user in a social networking site to create an intuitive hierarchy of topics for the containment of hundreds or thousands of items, for example. The size of the hierarchy, the capacity to support multiple item types, and/or the number of items in a topic folder are theoretically unbounded.

It will be appreciated that while different item types may be associated with a given topic-based collection or folder, a topic folder can still be configured to support only one item type if desired, as in item type 903 of folder 902, which allows it to simulate legacy structures, for example. It will more typically contain multiple item types, such as depicted by the listing of item types 904.

It will be further appreciated that topic-folders in the same hierarchy can also be fully independent from one another. For example, in FIG. 4, the folder hierarchy “Music” (905), “Artists” (906) and “U2” (907) are related to one another but each contains a different combination of item types. The “Music” folder could hold new postings about the music industry and categorized sub-folders such as “Artists”. The “Artists” folder might in turn be used to showcase video interviews with popular bands while also linking to artist search engines on the Internet. The “Artist” folder might contain hundreds of sub-folders, each focused on one artist, such as “U2”. The “U2” folder could then be used to describe the band, showcase album art and make sample music files available for download with matching lyrics.

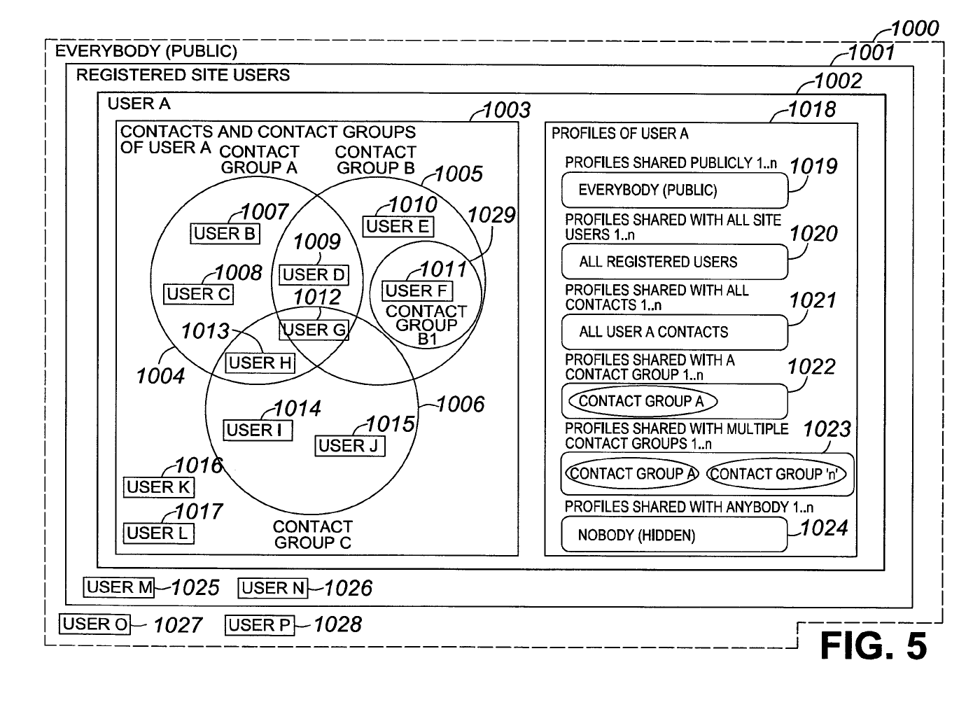

As noted above, the hierarchical data structure may also be used to advantage by allowing individual users to control access to multiple profiles for each user. This concept is further explained with reference to the embodiment of FIG. 5.

Typical social networking sites allow registered users to develop a single profile about themselves. This profile is used to showcase the user publicly or to other users of the site.

Also typical is the ability for two users in the site to create a connection between each other and thus be added to each other's “contact list”.

In one embodiment of the invention, a system is provided by which each user in a social networking site is able to manage multiple profiles and then be able to share those profiles with a sub-set of user populations, such as populations 1019 to 1024, which are exposed to the social networking site, as shown in FIG. 5.

In this embodiment, each user in the social networking site is able to manage a set of contact groups within which a user categorizes his own contacts, such as contact groups 1004 to 1006.

These contact groups can be structured hierarchically to facilitate selection and group assignment, for example including, but not limited to:
Acquaintances
Personal
   Family
   Friends
      Close Friends
Professional
   Co-Workers
   Business Contacts
   Business Partners

In FIG. 5, the concept of nested groups is illustrated by contact group B1 (1029) appearing wholly within contact group B (1005). Note that the groups do not have to be nested. It is, however, a useful structure when groups are logically inclusive of one another. For example, if a contact is placed into a sub-group, that user is automatically a member of any parent groups. As shown in FIG. 5, User F (1011) is a part of group B (1005) automatically by being placed into group B1 (1029). This approach is similar to designating a contact as a “Close Friend” and having that contact be automatically made a member of the groups “Friends” and “Personal” given the sample hierarchy presented above. To further explain, since “Close Friend” is a sub-group to “Friends”, the sub-group inherits the associations of its parents and grandparents (or ancestors). Thus, anyone grouped as a “Close Friend” automatically is made a member of “Friends” and of “Personal”. Similarly, anyone grouped as a “Friend” automatically becomes a member of the group “Personal”.

It will be appreciated that, in accordance with some embodiments, placing a contact into a group remains optional. It is also contemplated that a contact may be placed in more than one group if desired.

An advantage of embodiments providing contact groups is that once a user in the social networking site places his contacts into contact groups, the user can quickly and easily associate one or more of his online profiles with one ore more contact groups, and thus with a large number of people, in a single step. This ease of association is exemplified by the profile associations 1022 and 1023 shown in FIG. 5.

Still referring to the embodiment of FIG. 5, a user is provided various options to control how broadly a profile is exposed to other people. A profile can be shared publicly as shown by profile association 1019, with all registered users of the site as shown by profile association 1020, with all of his or her contacts as shown by profile association 1021, or just with users in select contact groups as shown by profile associations 1022 and 1023, for example. In this embodiment, it is also contemplated that the user creates a profile that is not yet shared with any users, as shown by profile association 1024.

Taking an example from FIG. 5, User A (1002) has 11 contacts (i.e., contacts 1007 to 1017). Only 9 have been placed into at least one contact group (i.e., groups 1007 to 1015). Some contacts are in more than one group (i.e., see contacts 1012, 1013 and 1009) and two of his contacts are not in any group at all (i.e., see contacts 1016 and 1017).

FIG. 5 also illustrates how certain profiles (i.e., profile associations 1019, 1020, and 1021) can be made visible to users that are not yet his contacts (i.e., see registered site users 1025 and 1026, and non-registered users in the pubic domain 1027 and 1028).

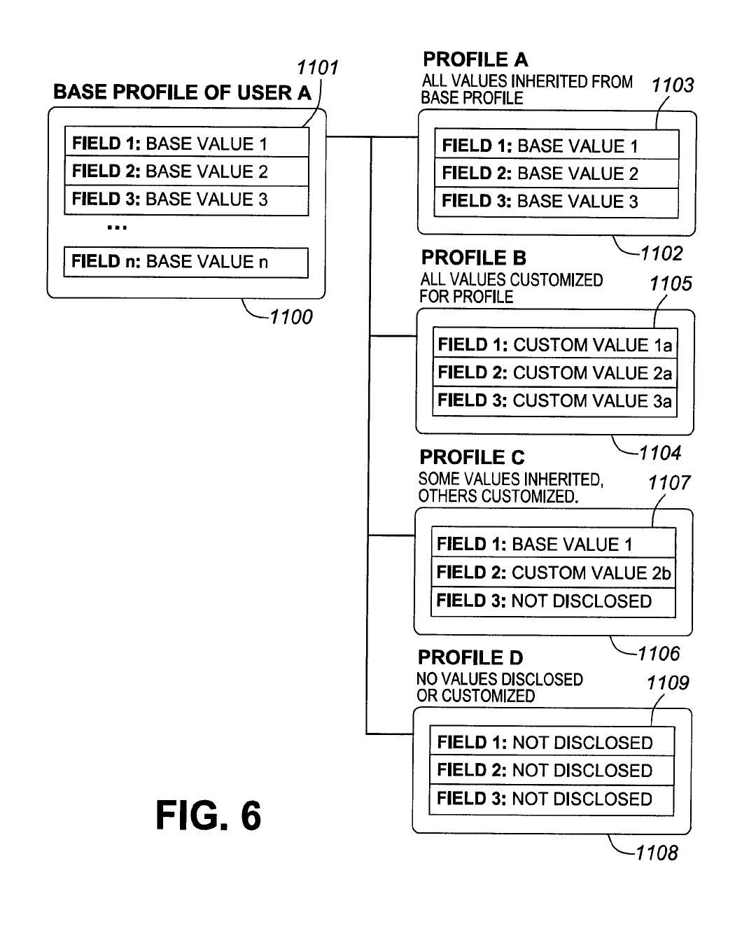

Referring now to FIG. 6, and in accordance with one embodiment of the invention, an example of a profile management method and system will now be described. In this particular embodiment, each individual user may be allowed to store information in a base profile 1101. This information can be selectively made part of each other profile created by the user. As an option, the hierarchical data structure presented above may be used to advantage with this feature by ensuring that the base profile is the root of the data tree that results from the various profiles. It will be appreciated, however, that other data structures may be considered herein to implement a multiple member profile system as described herein, and that systems using such alternative data structures are considered to fall within the scope of the present disclosure.

As introduced above, one embodiment of the invention provides a system by which each user in a social networking site is able to manage multiple profiles with different user populations, as depicted by profile associations 1102, 1104, 1106 and 1108.

In this embodiment, to allow a user to effectively manage a wide range of profiles, the system enables common information across multiple profiles to be viewed, added, updated and removed centrally, namely via a central container such as identified as “base profile” 1100 in FIG. 6.

Accordingly, a base profile in this example is therefore used to hold a number of profile field values, such as field value 1101 to allow these values to be later inherited or disclosed (i.e., see values 1103 and 1107) in profiles shared with others (i.e., see profiles 1102 and 1106 respectively).

In this example, a user may optionally create profiles that use only some base values (i.e., see value 1107 of profile 1106) or no base values at all (i.e., see custom values 1105 of profile 1104). Some profiles may further be composed of completely custom values (i.e., see values 1105 of profile 1104) or choose to have no values at all (i.e., see values 1109 of profile association 1108).

Another feature of the above noted social networking website is the ability for users to categorize their contacts as shown above. Each user is given the option, for each of his or her own contacts, to categorize these contacts. Users are presented with the option of placing each contact into predetermined categories (e.g. “Personal”, “Business”, “Friends”, etc.) or to create his or her own categories for the contacts. This organizational information (whether it is using the predetermined categories or user defined categories) is then used to organize the user's contacts.

In the example given above, a user's contacts are grouped into the different main contacts groups (or categories) of “Acquaintances”, “Personal”, and “Professional”. The contacts can then be further sub-categorized by the user into the sub-categories of “Family” and “Friends” (under the category of “Personal”) or into the sub-categories of “Co-Workers”, “Business Contacts”, and “Business Partners” (under the category of “Professional”). Further sub-categorization, such as sub-categorizing contacts into the sub-category “Close Friends” (a sub-category of the category “Friends”) is also possible. The hierarchical nature of the categories allows for this capability.

The user can categorize his or her contacts into these categories or into other user defined categories without any input from the contacts themselves. The user can enter this organizational information (either the new, user defined categories or the predetermined categories into which the user contacts can be grouped or categorized into) for each of his or her contacts and this is used by the system to organize the user's contacts. Once organized according to the categories desired by the user, the contacts can then be visually presented to the user in a manner that reflects what the user wanted in terms of organization.

It should be noted that the user's contacts need not be registered users of the website. Non-members of the website (or potential members awaiting registration or validation at the website) may be added as contacts by the user.

The categorization of a user's contacts can be used in multiple manners. The categorization of contacts can be used as the basis for determining which contacts can access which user content. As an example, a user may designate contacts in his “Personal” category as being able to access his photos and his videos but that contacts his “Professional” category may be designated as not being able to access the same content. Similarly, since the categorization is organized in an hierarchical manner, contacts in sub-categories may be able to access specific content while those categorized in the parent category may not be able to access the same content. As an example, using the example above, contacts in the “Close Friends” category may be designated as being able to access specific content but those contacts who are only categorized in the “Friends” category are not able to access the same content.

The above noted use of the categorization to control access to content may be extended to a user's contact list or lists. Thus, a user's contact, depending on his or her categorization by the user, may only be able to access some or none of that user's contact list. To further explain this, again using the above example, a contact categorized or classified as a “Close Friend” may be able to access the user's “Business Contacts” but that same user's contacts categorized as “Professional” may not be able to access that user's contacts in the “Personal” category.

As well, a user may use the categorization to control who has access to that user's profile or profiles. A contact may, therefore, only be able to access some or none (or even all) of a user's multiple (or single) profiles. Thus, if a user has a Personal profile, a Professional profile, and perhaps a “Fun” profile, that user may limit access to his Personal profile to only his contacts in the “Personal” category. Those contacts in his “Professional” category may, therefore, not be able to access the Personal profile. Similarly, the user may limit access to his “Fun” profile to only his “Close Friends”, thereby locking out all of his contacts, with the exception of his “Close Friends”, from the “Fun” profile. As noted above, each profile that a user generates exist independently of his or her other profiles. Of course, this concept extends to the possibility that a user may only have a single profile. In such a case, the user may limit access to that single profile to only some of his contacts.

Based on the above, it should be clear that a hierarchical data structure may be used to construct a social networking website or any other type of database-dependent software construct using the storage format explained with reference to FIG. 2 above. The data storage format may be used to identify specific nodes and its ancestry, while the data associated with that node (be it identifying information related to a profile, digital content associated with a content collection, or any type of digital data) may be accessed by means of a pointer to the actual location of the data in the database. If access to the actual data is desired, accessing and following the pointer will lead to the actual data. It should, however, be noted that profiles, contact groups and/or content collections used in such a social networking website may each or all have a data storage format different from the hierarchical data structure explained above. Use of such different data structures for the storage and organization of the user profiles, user contacts and groups, and content collections would still enable a workable social networking website.

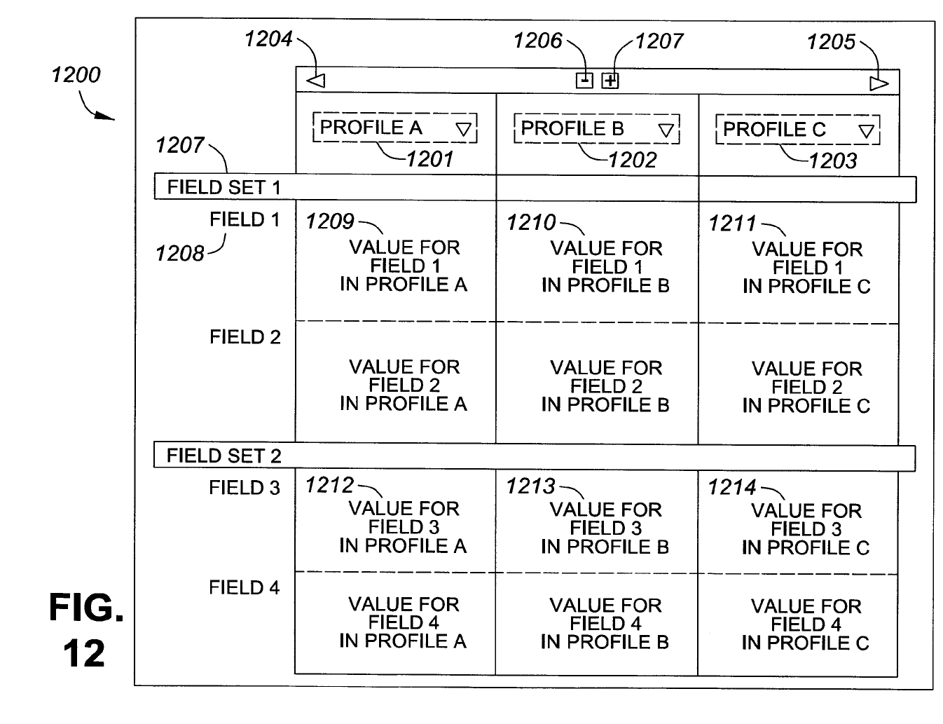

Referring now to FIG. 12 and in accordance with one embodiment of the invention, a user interface 1200 for managing a member's multiple profiles is described.

In this embodiment, the user interface 1200 is provided such that a member may manage the various profiles in his or her account, and particularly, manage information used and displayed in each of these profiles. In this example, the information is categorized amongst field sets (e.g., field set 1—1207) and reflects different identities (i.e., different identifying information) the member wishes to respectively display to users authorized to access different profiles. In this example, three profiles are displayed side-by-side in a same window or interface, wherein selection of the displayed profiles is provided via a drop box or menu, as in drop boxes 1201, 1202 and 1203. Accordingly, a member can compare information to be displayed in different profiles. For example, a field value 1209 for field 1 1208 of a profile A 1201 may be compared with field values 1210 and 1211 for a same field in profiles B 1202 and C 1203 respectively.

In order to enter information for a given field, various information selection and/or association functions may be implemented. For example, a field may be selected for a given profile (e.g., fields 1212, 1213 and 1214 for profiles A 1201, B 1202 and C 1203 respectively), and information entered or edited manually (e.g., via a file retrieval and upload function, direct data entry, form data entry, data box entry, etc.). In another option, information may be dragged and dropped from one profile to another, thereby facilitating distribution of information from one profile to the next.

In one embodiment, a toolbar identifying profile field option (e.g., data edit and entry functions, cut and paste functions, drag and drop functions, open field functions etc.) is highlighted as a cursor is moved over a given field box. By clicking or double clicking on the highlighted field, data entry/edit functions are automatically activated.

It will be appreciated that different numbers of profiles may be opened and/or viewed at a same time. For example, using the “+” 1207 and “−” 1206 features, the number of profiles viewable simultaneously in a given window may be increased and decreased respectively. Also, using the back 1204 and front 1205 arrows, a member may scroll through a number of opened profiles. Alternatively, the member may rather keep a reference profile opened in a first column, for example, such as a base profile or the like, and select alternative profiles to be compared therewith using the drop boxes described above.

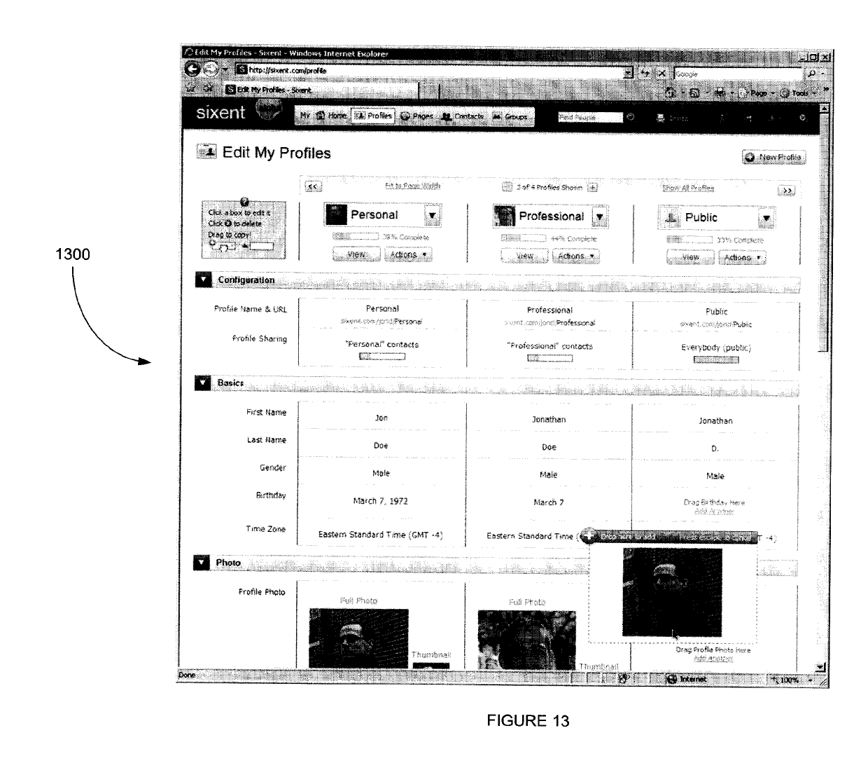

FIG. 13 provides an exemplary screenshot 1300 of graphical user interface similar to that described above with reference to FIG. 12. In FIG. 13, three profiles (“personal”, “professional” and “public”) are selected and juxtaposed in the window. In a configuration field set, “profile name & URL” and “profile sharing” fields are customized for each profile, identifying in this example, a function for establishing contacts or contact groups authorized access to each profile respectively.

With further reference to FIG. 13, in a “Basics” field set, the following fields are included: “First Name”, “Last Name”, “Gender”, “Birthday” and “Time Zone”. Each field includes identifying information selected by the member for display in these fields for each profile. For example, the user's first name may be abbreviated in a personal profile, whereas the full indication of the user's first name is provided in the professional and public profiles. Similarly, no birth date is provided for viewing in the public profile, whereas only the month and day are selected for display in the professional profile.

In a “Photo” field set, a representative photo and thumbnail are provided for each profile. In this example, the photo selected for the “personal” profile was selected and is being dragged for inclusion in the “public” profile.

It will be appreciated that a number of additional or alternative field sets and fields may be considered in this example without departing from the general scope and nature of the present disclosure.

As another exemplary enabler of the system explained above and as another aspect of the invention, the data format explained with reference to FIG. 2 and other bit arrays may be stored as a new data type regardless of the programming language used.

This aspect of the invention comprises a software class representation of a raw binary data structure, referred to herein as the bitmask class.

As is well known, a bit is a unit of information; it represents a binary digit, taking a value of either 0 or 1. Industry standard programming languages such as Java™ and C++ currently offer a BitSet class, which facilitates the manipulation of a variable length bit array, but they do not provide any methods to efficiently read or write the raw data to an underlying storage system. The serialization provided by these languages stores the data in a condensed but proprietary format that cannot be efficiently used. The reason is that the propriety format of it is not natively understood by third party storage systems.

The benefit of writing the complete bit array to an underlying storage system in its true or native form is that other programs, such as databases, can leverage this data to perform queries or comparisons against it without being dependent on what programming language was used to create the original software or any need to manipulate large data sets in the memory of the application accessing the database.

In accordance with one embodiment, a bitmask class is optimized to write out a single long number if the array length is 64 bits or less. This allows for a database to have a more direct way of querying the data without a need to find a subset and mask it to a numeric type. If the array length is more than 64 bits, the array may be stored as a pure bit array (raw binary array). The pure bit array can still be used in bitwise operations by using byte range functions to zoom in on specific ranges of bits in the pure bit array.

Some additional properties of this class may include:

the bitmask class contains an underlying byte array storage of variable length (i.e., the array size grows as further offsets are accessed);

the bitmask class can be instantiated from and persisted to an underlying physical storage system such as, but not limited to, a database or file;

the bitmask class provides methods to efficiently flip individual bits (turn on or off) at a given index;

the bitmask class provides methods to efficiently flip a range of bits (turn on or off) from a given index;

the bitmask class provides a method to efficiently compare or find any intersects against another Bitmask instance;

the bitmask class provides an efficient method to combine (“OR”) another bitmask instance;

the bitmask class provides an efficient method to return the index of the first bit that is set to true or false;

all bit manipulation is achieved by using bitwise operators and bit shifting against the underlying byte data.

There are many possible applications of this technique in a social networking site. One such application relates to the storage, retrieval and manipulation of user permissions (e.g. who can see or update an item). For example:

permissions can use the bitmask class to read and persist bit data to an underlying database;

only two bitmasks are required in a database to achieve complex permissions filtering and rapid lookups for all viewable folders and content items by a given user;

the first bitmask is stored with the user database record and represents which permissions group they belong to; this first bitmask is persisted to the database as a single field with the user;

every content item has a matching bitmask which represents which user groups are permitted to view the folder or item; this matching bitmask is persisted to the database in the single field with the folder or item;

by performing a bitwise operation on the first bitmask and the matching bitmask, the system can determine whether a given user has access to the given object.

all bitmasks are stored as a series of “Long” data type values which can be compared mathematically in a single SQL statement; the system can therefore efficiently return a list of intersecting items or folders that are viewable by any given user.

The bitmask class, as it relates to the storage and retrieval of complex permissions, can also be used, in accordance with one embodiment, to rapidly summarize a person's activities throughout the social networking site. For example, this summary can be of a single user or group of users and can be generated with minimal or no impact on performance. This makes it possible to create a news feed of logged activities, also referred to herein as an “activity stream.” For example, an activity stream can be created for all of a user's own contacts that are established in the network. The system can create the activity stream in a single database query while never revealing any activity related to items or profiles the user is not permitted to see.

What follows is an example of a simplified sample SQL query:

Select * from content

JOIN user on content.permissions & user.groups

and user.user_id=?

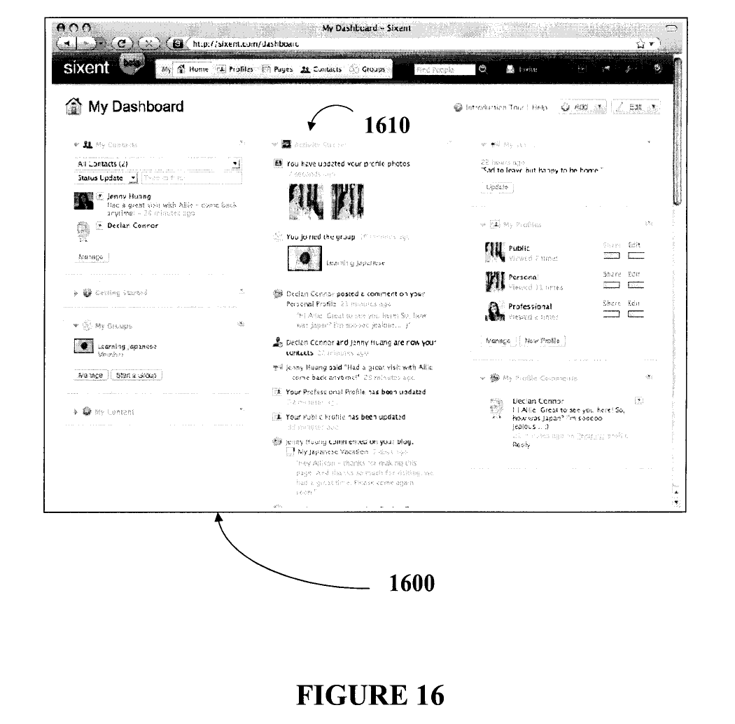

FIG. 16 shows an exemplary screen shot of a graphical user interface 1600 implemented by a networking system, in accordance with an embodiment of the invention, enabling a member to generate a personal home page, labelled a “Dashboard” in FIG. 16. In addition, the screen shot shows a news feed of logged activities as an “activity stream” 1610. An activity stream can be defined as a listing of content items from one or multiple areas. In accordance with an embodiment of the invention, any listing of content items from one or multiple areas can be summarized to a user very efficiently while respecting the complex permission settings. For example, a site with a deep arrangement of nested folders can still be quickly summarized, despite each folder and individual item potentially having unique combinations of permission settings. Thus, a member's activity stream is highly filterable.

As shown in FIG. 16, the “activity stream” 1610 for this particular member displays content associated with, and created by, other users. Because of the efficiency of the networking system in managing complex permission settings, the member can view the content created by other users shortly after creation despite, even though permission settings must be checked before the system will upload another user's content into the “activity stream.”

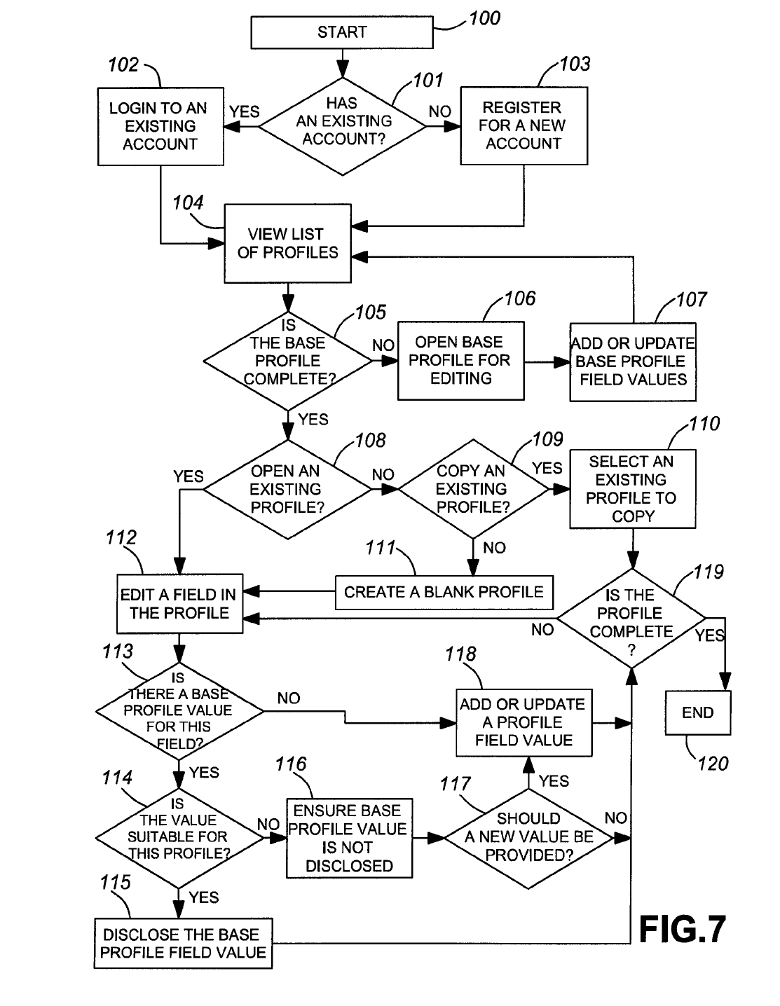

The operation of the social networking website explained above is detailed in FIGS. 7 to 11.

Referring now to FIG. 7, the steps taken to create a profile and an extended profile are detailed in accordance with one embodiment of the invention.

Step 100: The actor in this flowchart is that of basic end user of a social networking site. The user intends to create a description of himself in the format of an online profile. The user is permitted to have more than one profile and as such has some information that will repeat itself (e.g. same phone number for personal and professional use). The user can exploit a “Base” profile which is never shared with anyone else but serves to hold information common to multiple profiles. Having a Base profile saves time and ensures that later, the updating of information is effortless as compared to manually updating each profile separately with the same change.

Step 101: To begin, the user must have an account at the site. If the user has an account, he can login with the credentials he had previously defined (step 102). If not, the user must register for an account to establish himself for the first time (step 103).

Step 102: The user identifies himself by providing his credentials. This is typically, but is not limited to, entering the email address and password provided upon registration.

Step 103: The user is visiting the site for the first time and must create an account. This typically includes, but is not limited to, providing a name, email address and a password for the new account. Upon registration, the account will be automatically provisioned a Base profile and a public profile

Step 104: Once authenticated, a user can view a list of the profiles he has within the site. There is always a Base profile and a public profile.

Step 105: Prior to creating a profile to share with other people at the site, the user may want to first complete the Base profile for the benefits stated above (step 100). If it is already complete, the user will proceed to editing or creating a standard profile (step 108)

Step 106: The user opens the Base profile to edit its contents if it is not yet complete.

Step 107: The user can modify one or more profile fields in the Base profile.

Step 108: Once the Base profile is complete, the user must decide if he wants to edit an existing profile (step 112) or create a new one (step 109).

Step 109: The user wants to create a new profile and is provided the opportunity to copy an existing profile to save time (step 110). If not, the user can start with an empty profile (111).

Step 110: The user wants to copy a profile and thus must select an existing profile to copy. He can only copy from his own profiles or template profiles provided by the site.

Step 111: The user creates a blank profile. The blank profile does not include any values and must be edited further (step 112) before it is deemed complete (step 119).

Step 112: While editing a new or existing profile, a user can select any of the profile fields to edit.

Step 113: While editing a particular field, the system will indicate to the user that there is information already present for this field in the Base profile.

Step 114: The user must decide if the Base value is appropriate for the given profile.

Step 115: The Base value is appropriate for the given profile field, so the user must disclose the Base value if it is not already disclosed.

Step 116: The Base value is not appropriate for the given profile field, so the user must undisclose the Base value if it is not already undisclosed.

Step 117: If the Base value is not being used, however, the user can still decide if he has a value that is suitable for the given field.

Step 118: The user adds or edits a profile field value that is specific to the given profile. This field value will not appear in the Base profile or other profiles.

Step 119: Upon copying or editing a profile, a user can continue to edit it further (112) or consider it complete and end the profile editing process (step 120).

Step 120: The profile editing process is complete.

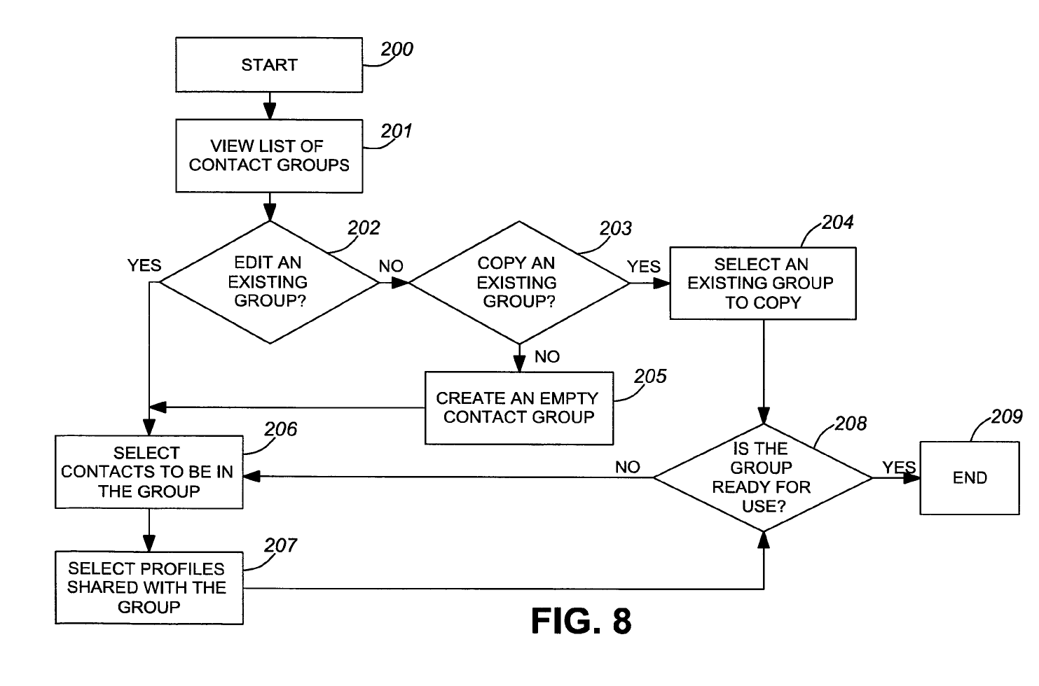

Referring to FIG. 8, the steps taken when editing a contact group or assigning contacts is detailed in the flowchart, in accordance with one embodiment of the invention.

Step 200: The actor in this flowchart is that of basic end user of a social networking site. This flowchart assumes the user is already logged into the site. The user intends to create a group to organize his contacts and will then use those groups to determine who can see a profile previously created within the site. A contact can be placed in zero or more groups and each group can be given access to zero or more profiles.

Step 201: The user begins by viewing a list of the contact groups that are associated to his account.

Step 202: The user can choose to edit an existing group (step 206) or create a new group (step 203).

Step 203: When creating a new group, a user is given the opportunity to copy an existing group (step 204) or create a new group that is empty (step 205).

Step 204: The user wants to copy a contact group and thus must select an existing contact group to copy. He can only copy from his own contact groups.

Step 205: The user creates an empty contact group. The new contact group does not include any contacts.

Step 206: While editing a particular group, the user updates which of his existing contacts are to be included in the group. Contacts can be quickly added or removed.

Step 207: While editing a particular group, the user selects which of his existing profiles should be shared with the contacts in the group. Profiles that are not already shared with all contacts can be added or removed as required.

Step 208: The user must decide if the contact group is ready for use (209). If not, the user can return to edit it (206).

Step 209: The contact group editing process is complete.

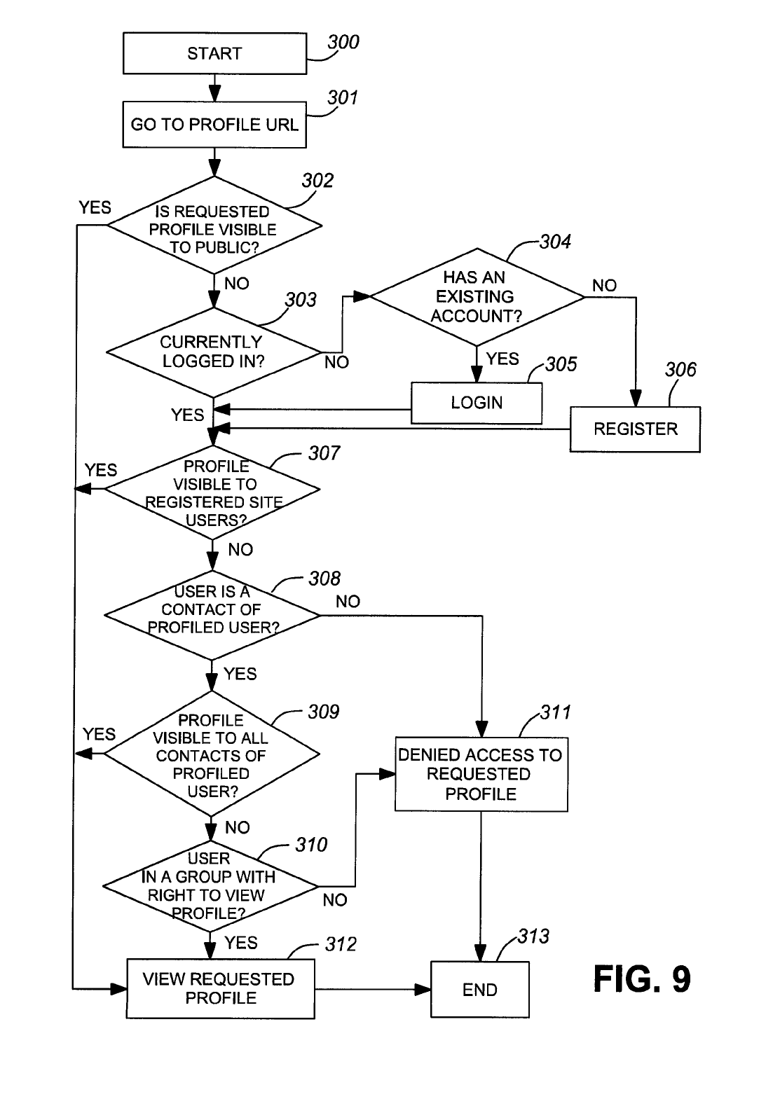

Referring to FIG. 9, the steps taken when viewing a user profile is detailed, in accordance with one embodiment of the invention.

Step 300: The actor in this flowchart is that of a basic end user of a social networking site. This flowchart assumes the user has been provided a URL to another user's profile. The URL may be received by email, instant message, phone, in person, in print, etc.

Step 301: The user begins by opening the given profile URL in a Web browser or similar software. The URL is a dedicated address to another user's profile in the social networking website.

Step 302: If the profile requested is open to the public, no security verification steps are required and the user is permitted to immediately view the profile (step 312)

Step 303: The profile is not public, the user must be logged into the site to view it. If the user is already logged in, the process can continue (step 307).

Step 304: The user is not already logged in and must decide if he already has an account with the site (step 305) or needs to register for a new account (step 306).

Step 305: The user already has an account and thus authenticates himself with the site by entering his credentials. This is typically done by providing the email address and password supplied to the site upon initial registration.

Step 306: The user does not already have account at the site and has chosen to register for a new account. This typically requires at least the user providing his name, email address and a password for future authentication.

Step 307: If the requested profile is not public but it is open to all registered users of the social networking site, any user that is logged into the site is permitted to view the profile immediately (step 312).

Step 308: If the requested profile is not shared with all site users and the current user is not a contact of the profiled user, access will be denied (step 311).

Step 309: The requesting user is a contact of the profile user. If the requested profile is not visible to all of the profiled user's contacts, and the user is not in a group with the right to view the profile, access will be denied (step 311).

Step 310: If requesting user is part of a contact group managed by the profiled user and one of those groups has permission to view the profile, the profile can be viewed (step 312). If not, the user is denied access (step 311).

Step 311: The user is not permitted to view the requested profile.

Step 312: The user is permitted to view the requested profile.

Step 313: The process for viewing a profile is complete.

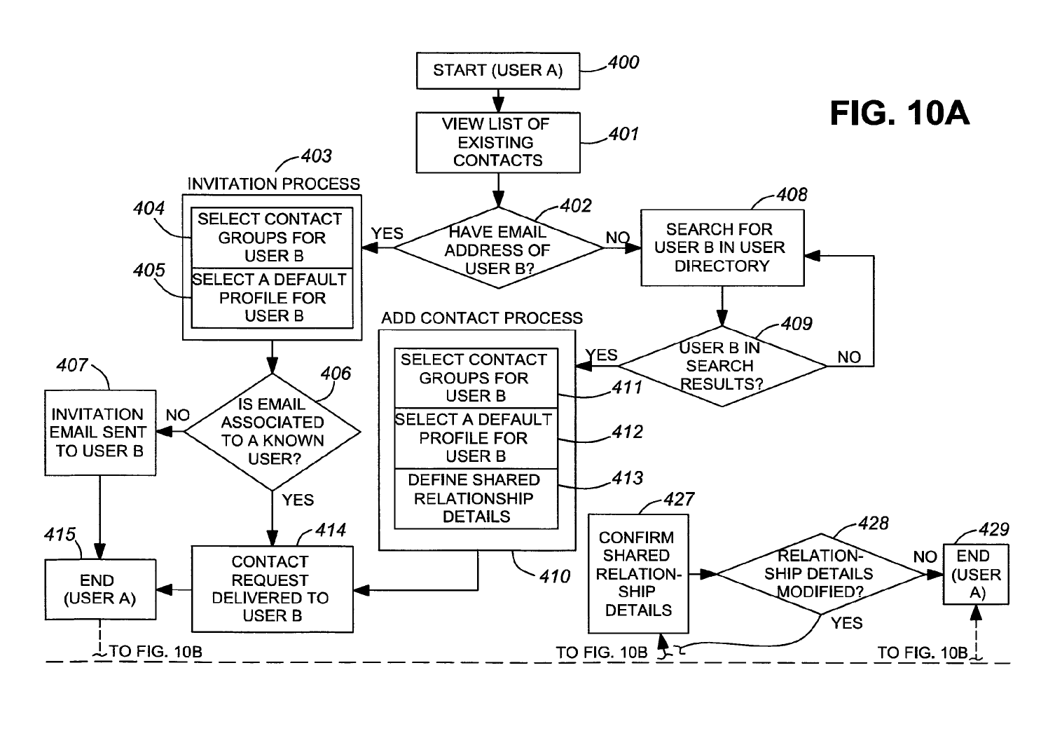

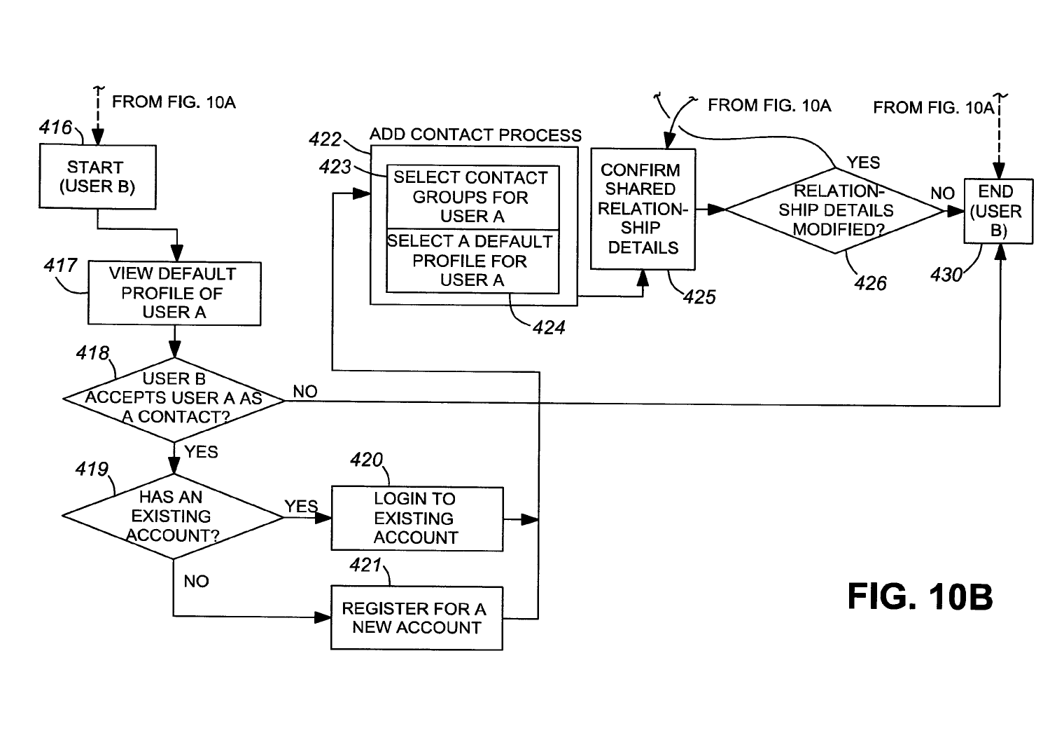

If two users are in the process of establishing contact with one another, the steps taken for such a transaction are detailed in FIG. 10, in accordance with one embodiment of the invention.

Step 400: There are two actors in this flowchart. The first actor, “User A”, is a user that intends on establishing a connection with another user, “User B”, in the social networking site. User B intends to accept the request to connect. At the end of the process, the two users will be considered to be “contacts” with one another.

Step 401: User A begins the process by entering the site to view a list of his existing contacts. It is assumed at this point that User A is a registered user of the site already and has authenticated himself prior to this step.

Step 402: If User A has the email address of User B, an email-based invitation can be initiated (step 403). If not, User A must search for User B in an open directory of users provided by the social networking site (step 408)

Step 403: User A has the email address of User B and supplies it to a brief invitation process.

Step 404: During the invitation process, User A determines how User B should be placed within his contact groups.

Step 405: Through to selection of contact groups, User A is indirectly indicating a willingness to share one or more of his profiles with User B. User A can choose which of the shared profiles will be “default” or primary profile.

Step 406: Upon completion of the invitation process, the system will compare the provided email address against all users that have registered in the site. If the email address is found, the user is sent a contact request (step 414).

Step 407: The email address provided by User A is not already associated to a registered user in the site. An email is sent to the provided address. The user is sent an invitation email requesting that he join the site as well as become a contact of User A (step 407).

Step 408: User A does not have the email address of User B and must search for User B in an open directory of users provided by the site. This is typically done by supplying all or a part of the desired user's name and/or geographic location.

Step 409: User A has submitted a search criteria to the site. A search result consisting of matching users appears. If User B cannot be located, User A can modify his criteria and try again (step 408). If User B is located, User A can choose to start the “Add Contact Process” (step 410).

Step 410: User B is located at the site and User A has chosen to start the “Add Contact Process”.

Step 411: During the “Add Contact Process”, User A determines how User B should be placed within his contact groups.

Step 412: Through to selection of contact groups, User A is indirectly indicating a willingness to share one or more of his profiles with User B. User A can choose which of the shared profiles will be “default” or primary profile.

Step 413: User A can choose to define the nature of his relationship with user B. This relationship status will be shared with other users in the site to provide context. User B will therefore have to approve these value as well (step 425).

Step 414: A contact request is sent to User B. This is typically, but not limited to, an email requesting that User B visit the site and complete the process to connect with User A.

Step 415: The process of connecting with User B is complete for User A unless User B later updates the shared relationship details that User A would have to re-approve (step 428). User A must now wait for User B to accept his request to become a contact.

Step 416: User B becomes involved in the process by receiving a request from User A to be his contact. This typically takes the form of an email message but it may also be indicated to User B while he is using the social networking site. This flowchart assumes User B is not logged into the site already.

Step 417: User B begins by viewing the profile of User A. If the request to connect was received by email, the URL to User A's profile is included in the message. User B will be directed to the “default” profile set by User A when User A started the process.

Step 418: User B has the opportunity to accept the contact request from User A (step 419) or decline the request (step 431)

Step 419: To accept User A's request to be a contact, User B must be a registered user of the site. If user B already has an account, he can just login to authenticate himself (step 420). If not, the user must register for a new account (step 421).

Step 420: The user already has an account and thus authenticates himself with the site by entering his credentials. This is typically done by providing the email address and password supplied to the site upon initial registration.

Step 421: The user does not already have account at the site and has chosen to register for a new account. This typically requires at least the user providing his name, email address and a password for future authentication.

Step 422: User B begins the “Add Contact Process” to wrap up the larger process of accepting User A's request to become a contact.

Step 423: During the “Add Contact Process”, User B determines how User A should be placed within his contact groups.

Step 424: Through the selection of contact groups, User B is indirectly indicating a willingness to share one or more of his profiles with User A. User B can choose which of the shared profiles will be the “default” or primary profile.

Step 425: User B is shown the definition provided by User A (step 413) that describes the nature of their relationship. This relationship status can be accepted as-is or be modified by User B at this time.

Step 426: If User B modified the shared relationship details during the confirmation process (step 425), User A must be given the opportunity to review those changes (step 427). If not, the process is complete (steps 430 and 429).

Step 427: User A reviews, confirms, and approves any changes made to the shared relationship details. If User A modified the shared relationship details during the confirmation process (step 427), User B is again given the opportunity to review those changes (step 425). If not, the process is complete (steps 429 and 430).

Step 429: The process is complete for User A and, in turn, for User B as well (step 430).

Step 430: The process is complete for User B and, in turn, for User A as well (step 429).

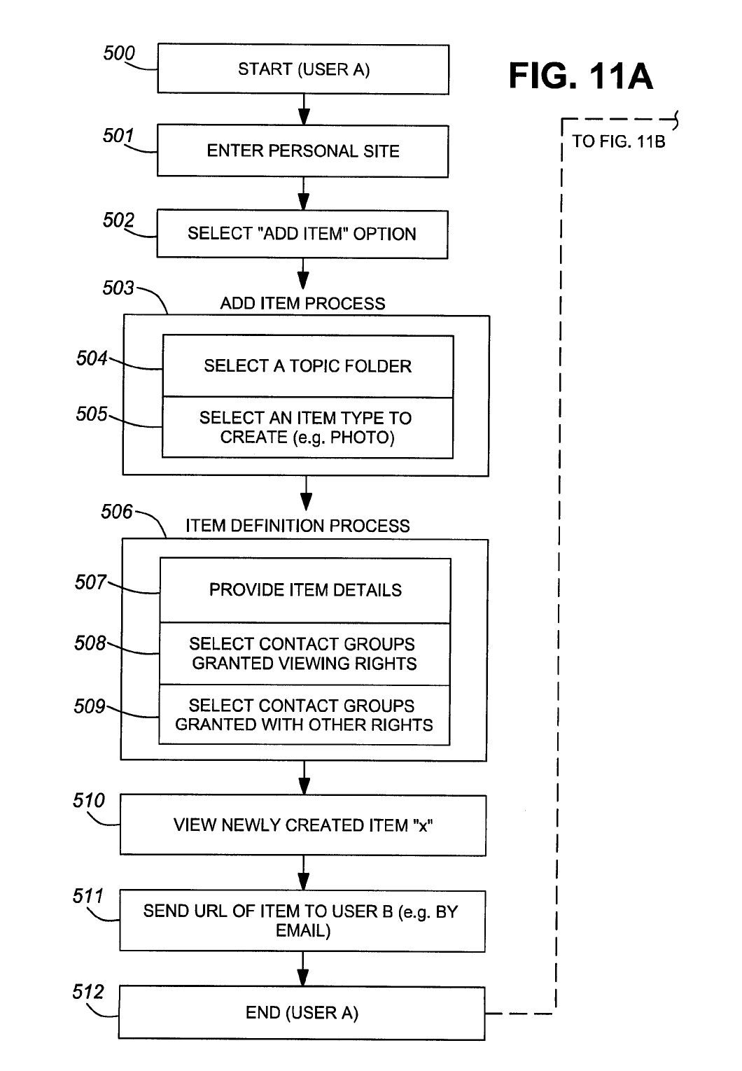

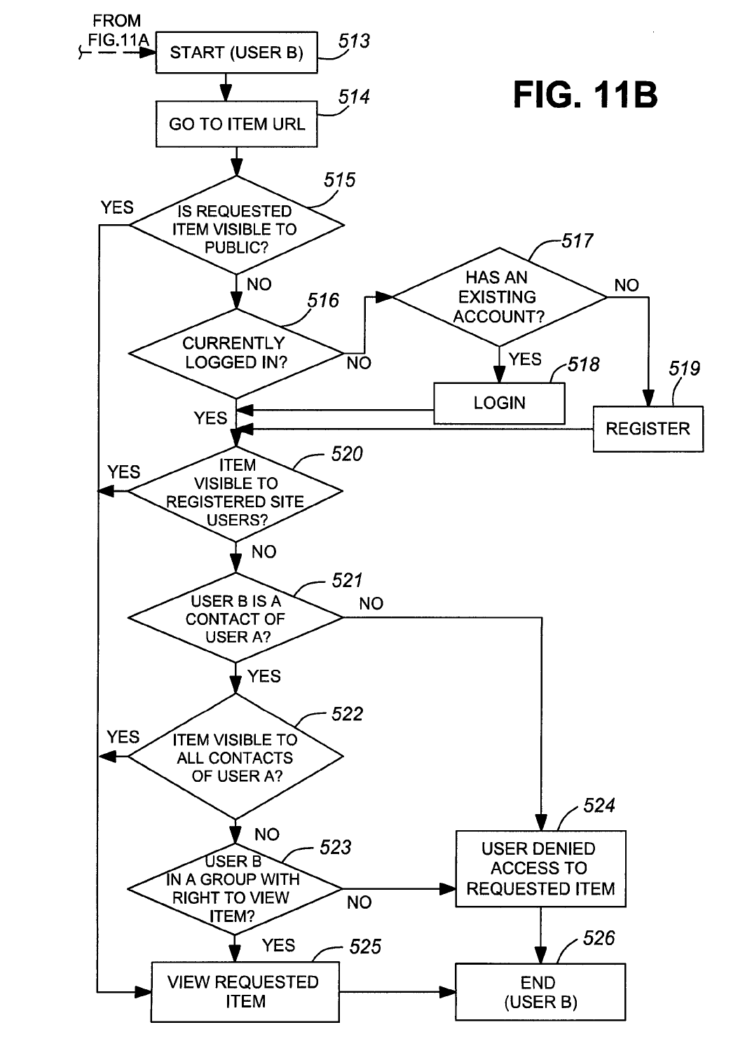

In FIG. 11, the steps taken when publishing content in a topic folder are detailed, as well as the steps taken when another user views the content, in accordance with one embodiment of the invention.

Step 500: There are two actors in this flowchart. The first actor, “User A”, is a user that intends on publishing an item to a topic folder and having another user, “User B”, view the newly created item. User B intends to view the item. User A begins the process. This flowchart assumes user A is already a registered member of the site and has already authenticated himself.

Step 501: User A accesses his own personal sub-site within the larger social networking site. This is an area in which User A is permitted to publish items.

Step 502: User A chooses to begin the “Add Item Process”

Step 503: The “Add Item Process” has been initiated which will take the user through the steps required to create a new item.

Step 504: The first step of the “Add Item Process” is to select which topic folder will contain the newly created item. A topic folder is a container that can hold any type of item the user is permitted to create in this process.

Step 505: The next step of the “Add Item Process” is to select the type of item to be created. The choices will vary greatly in different sites or based on what the user is permitted to create. Examples of item type include a digital photo, a computer file, a blog entry (text), a calendar, event, an opinion poll, and so on.

Step 506: The “Item Definition Process” follows next as it permits the specific type of item to be defined by the user as well as control who can see it.

Step 507: User A defines the particulars of the item being created.

Step 508: User A selects who will be permitted to view the new item by selecting one or more of his own contact groups.

Step 509: User A can also establish other permissions (e.g. right to view and add comments) that will be associated to the new item as well.

Step 510: Upon completion of the “Item Definition Process”, User A will be shown the new item.

Step 511: User A sends the unique URL, or address, to User B.

Step 512: The process is complete for User A as he awaits user B to respond by viewing the new item.

Step 513: The process begins for User B by receiving the URL address of an item created by User A.

Step 514: The user begins by opening the given item URL in a Web browser or similar software. The URL is a dedicated address to the item in the social networking website.

Step 515: If the item requested is open to the public, no security verification steps are required and the user is permitted to immediately view the item (step 525).

Step 516: The item is not public, the user must be logged into the site to view it. If the user is already logged in, the process can continue (step 520).

Step 517: The user is not already logged in and must decide if he already has an account with the site (518) or needs to register for a new account (step 519).

Step 518: The user already has an account and thus authenticates himself with the site by entering his credentials. This is typically done by providing the email address and password supplied to the site upon initial registration.

Step 519: The user does not already have account at the site and has chosen to register for a new account. This typically requires at least the user providing his name, email address and a password for future authentication.

Step 520: If the requested item is not public but it is open to all registered users of the social networking site, any user that is logged into the site is permitted to view the item immediately (step 525).

Step 521: If the requested item is not shared with all site users and the User B is not a contact of the User A, access will be denied (step 524).

Step 522: User B is a contact of User A. If the requested item is not visible to all of User A's contacts, access will be denied (step 524).

Step 523: If User B is part of a contact group managed by User A and one of those groups has permission to view the item, the item can be viewed (step 525). If not, the user is denied access (step 524).

Step 524: User B is not permitted to view the requested item.

Step 525: User B is permitted to view the requested item.

Step 526: The process for viewing the item is complete.

Having now described the various features, advantages and operation of various exemplary embodiments of the present invention, it will be appreciated by the person of ordinary skill in the art that such embodiments may be implemented in a number of ways, for example, using different approaches and techniques available in information and/or computer technology. For example, different embodiments of the invention may be implemented in different conventional computer programming languages. For example, some embodiments may be implemented in a procedural programming language (e.g., “C”) or an object oriented language (e.g., “C++”). Other embodiments of the invention may be implemented as pre-programmed hardware elements, other related components, or as a combination of hardware and software components, for example.

Some embodiments can be implemented as a computer program product for use with a computer system. Such implementation may include a series of computer-readable statements and instructions fixed either on a tangible medium, such as a computer readable medium (e.g., a diskette, CD-ROM, ROM, fixed disk, etc.) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer statements and instructions may embody all or part of the functionality previously described herein. Those skilled in the art should appreciate that such computer instructions can be written in a number of programming languages for use with many computer architectures or operating systems. Furthermore, such instructions may be stored in different memory devices, such as semiconductor, magnetic, optical or other memory devices, and may be transmitted using various communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

Various embodiments of the invention can also be implemented in digital electronic circuitry, or in computer hardware, firmware, software, or in combination thereof. Embodiments of the invention can be implemented in a computer program product tangibly embodied in a machine-readable storage device for execution by a programmable processor; and methods can be performed by a programmable processor executing a program of instructions to perform functions of the invention by operating on input data and generating output. Some embodiments of the invention can be implemented in one or more computer programs that are executable on a programmable system including at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and specific microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; CD-ROM disks; and buffer circuits such as latches and/or flip flops. Any of the foregoing can be supplemented by, or incorporated in ASICs (application-specific ICs), FPGAs (field-programmable gate arrays) or DSPs (digital signal processors).

A system embodying the invention may comprise, for example, a processor, a random access memory, a hard drive controller, and an input/output controller coupled by a processor bus. Other system configurations should now be apparent to the person of ordinary skill in the art.

It will be apparent to those skilled in this art that various modifications and variations may be made to the embodiments disclosed herein, consistent with the invention, without departing from the spirit and scope of the invention.

Other embodiments consistent with the invention will become apparent from consideration of the specification and the practice of the invention disclosed therein. Accordingly, the specification and the embodiments are to be considered exemplary only, with a true scope and spirit of the invention being disclosed by the following claims.

1. A method for providing selective access to electronic content associated with a member of a social networking system, the method comprising the steps of:
(a) generating a member account having at least one topic-based content collection;
(b) associating at least one electronic content item with at least one of the topic-based content collections responsive to a content selection action implemented via the member account;
(c) identifying at least one user as authorized to access the at least one electronic content item responsive to a user selection action implemented via the member account; and
(d) providing access to the at least one electronic content item, associated with at least one of the topic-based content collections, only to the at least one user identified as authorized in step (c).

2. The method according to claim 1, wherein at least one electronic content item associated with at least one of the topic-based content collections includes a combination of electronic content types.

3. The method according to claim 1, wherein at least one electronic content item associated with at least one of the topic-based content collections is selected from a group consisting of: uploaded data; digital media files, including text, video, audio and image media files; links to digital media files stored by a third party system; original work generated through the social networking system, including data, text entries, commentary, blogs, event entries, digital invitations, and meeting requests.

4. The method according to claim 1, wherein the step (c) of identifying at least one user authorized to access each of the content items comprises the steps of:
(c1) grouping the at least one user with at least one contact group,
(c2) identifying at least one contact group authorized to access the at least one content item, and
(c3) providing access to the at least one content item only to the at least one contact group identified as authorized in step (c2).

5. The method according to claim 4, wherein the step (c1) of grouping includes grouping the at least one user in a sub-contact group that is nested within the at least one contact group, such that the at least one contact group has a hierarchy of contact groups, and wherein the at least one user grouped in the sub-contact group has authorized access to the at least one contact group.

6. The method according to claim 1, wherein the step (c) of identifying at least one user authorized to access each of the content items further includes the steps of:
identifying the at least one user authorized to access a given content collection, and
providing the at least one user access to at least one content item associated with the given content collection.

7. The method according to claim 4, wherein the step (c) of identifying users authorized to access each of the content items further includes the steps of:
(c5) identifying the at least one user authorized to access a given content collection,
(c6) providing the at least one identified user access to a first content item associated with the given content collection, and
(c7) preventing the at least one identified user from accessing a second content item associated with the given content collection.

8. The method according to claim 1, wherein step (a) further includes the step of generating in the member account at least one member profile, and wherein step (b) further includes the step of associating identifying information with at least one of said at least one member profile responsive to an information association action implemented via the member account.

9. The method according to claim 1, wherein the step (c) of identifying at least one user as authorized to access the electronic content item includes identifying at least one user selected from a group consisting of: family, friends, professional contacts, business contacts, colleagues, social contacts, acquaintances, teammates, and co-workers.

10. The method according to claim 1, further including the steps of: sending, via the member account, an invitation to a non-user to register with the social networking system, and generating a shell user account for the non-user that is activated with a new member account when the non-user registers.

11. The method according to claim 1, further including the step of listing as an activity stream via a graphical user interface.

12. (canceled)

13. A method for providing selective access to identifying information associated with a member of a social networking system, the method comprising the steps of:
(a) generating a member account having at least one member profile;
(b) associating identifying information with at least one of said at least one member profile responsive to an information association action implemented via the member account;
(c) identifying users authorized to access at least one of said at least one member profile responsive to a user selection action implemented via the member account; and
(d) providing access to identifying information associated with at least one of said at least one member profile only to users identified as authorized to access said at least one member profile.

14. A method according to claim 13, further including the step of generating at least two member profiles for said member account and wherein the step (b) of associating identifying information includes, via a graphical user interface, juxtaposing the at least two member profiles for viewing by the member, and providing an option for associating identifying information in a first member profile with a second member profile in response to a member selection action.

15. The method according to claim 13, further including the step of generating at least two member profiles for said member account and wherein the step (b) includes associating identifying information in accordance with a predefined information field, and providing an option for associating different identifying information with predefined information field common to the at least two member profiles.

16. The method according to claim 13, the step (b) of associating identifying information includes, via a graphical user interface, selecting a graphically rendered identifying information item representative of identifying information and associating the graphically rendered information with a selected graphically rendered profile representation.

17. (canceled)

18. A social networking system for providing selective access to electronic content associated with a member of the system, the system comprising:
at least one data storage device for storing data associated with an account of the member and at least one topic-based content collection thereof, the data comprising collection-related data for each of the topic-based content collections, user-related data for at least one user, and content-related data associated with the electronic content; and
at least one processing module operatively coupled to the at least one data storage device and configured with:
at least two user interface components for implementing an account management interface enabling a content association function and a user association function;
a content association component for implementing, responsive to the content association function, association of the content-related data with the collection-related data of a selected topic-based content collection; and
a user association component for implementing, responsive to the user association function, association of the user-related data of a selected user with the content-related data and the collection-related data of the selected topic-based content collection;
wherein the at least two user interface components are constructed and arranged for implementing a user interface for providing access to the electronic content only to the selected user.

19. The system according to claim 18, wherein the at least one data storage device has a system of servers for storing the data, and wherein the system of servers has a data storage configuration for a hierarchical organization of the user-related data and the content-related data into respective nested levels.

20. The system according to claim 18, wherein the at least one data storage device is constructed and arranged to store the topic-based content collections and electronic content associated with the topic-based content collections, such that access by the selected user to the topic-based content collections and its associated electronic content is based on criteria selected by the member.

21. The system according to claim 18, wherein the at least one data storage device is configured with:
a master database cluster for storing a unique identifier for each user of the system and some user-related data, and for maintaining a main federated database table, and
at least one shard database cluster, operatively coupled to the master database cluster, for storing the content-related data and the collection-related data in individual shards,
wherein the main federated database table is federated into the at least one shard database cluster to enable the at least one processing module to retrieve specific data from the at least one shard database cluster.

22. The system according to claim 18, wherein the at least one data storage device has a database, configured with a high-density data storage format, for storing path ancestry information for each node in a hierarchy of nodes using a raw byte array, such that path ancestry information for each node is readily retrievable from the database.

23. The system according to claim 18,
wherein the user association component is constructed and arranged to associate user-related data with at least one contact group, and
wherein the user association component is constructed and arranged to associate the at least one contact group with the content-related data and the collection-related data of the selected topic-based content collection.

24. The system according to claim 23, wherein the user association component is constructed and arranged to associate user-related data with at least two contact groups, wherein at least one data storage device has a system of servers, and wherein the system of servers has a data storage configuration that provides a hierarchical organization of the at least two contact groups into nested levels.

25. The system according to claim 18, wherein the data is stored in the at least one data storage device as a bit array according to a specific bitmask class, and wherein the data is retrieved from the at least one data storage device using a bitmask to extract the status of at least one bit in the bit array.

26. The system according to claim 18, wherein the at least one storage device is constructed and arranged to store a bitmask with user-related data, such that the bitmask represents a contact group of users associated with the selected user.

27. The system according to claim 18, wherein the at least one storage device is constructed and arranged to store a bitmask with content-related data, such that the bitmask represents selected user groups having access to the content-related data.

28. The system according to claim 18, wherein the at least two user interface components are constructed and arranged for implementing a user interface that displays specified associations of the content-related data with the collection-related data of a selected topic-based content collection made within a member account.

29. The system according to claim 18,
wherein the at least two user interface components are constructed and arranged for implementing a user interface that provides a list of specific content-related data from at least one topic-based content collection, and
wherein the user interface is constructed and arranged for a given user to manipulate and modify the list within the user interface.

30. The system according to claim 18, wherein the topic-based content collection is a topic folder containing different types of electronic items selected from a group consisting of: computer files, calendar entries, photos, formatted text postings, databases, discussion topics, videos, audio files, opinion polls, and other topic folders.

31. A social networking system for providing selective access to identifying information associated with a member of the system, the system comprising:
at least one data storage device for storing data associated with an account of the member and at least one member profile thereof, the data comprising profile-related data for the or each of the profiles, user-related data for each of a plurality of system users, and identifying information-related data associated with the identifying information; and
at least one processing module operatively coupled to the at least one data storage device and configured with:
at least two user interface components for implementing an account management interface enabling an identifying information association function and a user association function;
an identifying information association component for implementing, responsive to the identifying information association function, association of the identifying information-related data with the profile-related data of a selected profile; and
a user association component for implementing, responsive to the user association function, association of the user-related data of a selected system user with the profile-related data of the selected profile;
wherein the at least two user interface components is further for implementing a user interface for providing access to the identifying information via the selected profile only to the selected system user.

32. A method according to claim 31, wherein said at least one member profile comprises at least two member profiles and each of the at least two member profiles has a different set of identifying information associated with the member account.

33. A system according to claim 32,
wherein the at least two user interface components are constructed and arranged for managing the at least two member profiles, such that the member profiles are displayed in a single user interface, and
wherein the single user interface is constructed and arranged to compare profile-related data and information-related data between the at least two member profiles, such that the profile-related data and information-related data within the at least one member profile can be changed.

34. A system according to claim 18, wherein the system has a multi-tenant architecture, wherein the at least one storage device has a database that is constructed and arranged to virtually partition its data and configuration to provide a customized virtual application of the system to a client organization, such that members of the client organization and associated data are segregated from any other system members and their associated data.

35. A method for operating a social networking website, said site having a plurality of users, the method comprising:
receiving input from each user comprising contact information for a plurality of said user's contacts;
receiving organizational information from each user for each of said user's contact for use in organizing said user's contacts into categories;
categorizing each user's contacts based on said user's organizational information for each contact;
for each user, presenting said user's contacts to said user in an organized manner reflecting said user's organizational information for each contact.

36. A method according to claim 35 wherein at least one of said user's contacts is also a user of said site.

37. A method according to claim 35 wherein said contacts are categorized into a hierarchical organization of categories.

38. A method according to claim 37 wherein at least one category in said hierarchical organization is nested in another category.

39. A method according to claim 36 wherein, for each user, each contact's access to said user's content in said site is based on which category said contact is categorized into.

40. A method according to claim 36 wherein, for each user, each contact's access to said user's contact list in said site is based on which category said contact is categorized into.

41. A method according to claim 36 wherein, for each user having at least one profile, each contact's access to the or each of said user's at least one profile is based on which category said contact is categorized into.
